(19) United States
(12) Patent Application Publication
(10) Pub. No.: US 2025/0206523 A1
(43) Pub. Date: Jun. 26, 2025

(54) SYSTEMS AND METHODS FOR OPERATING AN ELECTRIC LIFT SYSTEM FOR AN ELECTRIC REFUSE VEHICLE

(71) Applicant: Oshkosh Corporation, Oshkosh, WI (US)

(72) Inventors: Chris Rukas, Oshkosh, WI (US); Cole Adams, Oshkosh, WI (US); Luke Gustafson, Oshkosh, WI (US); John Wolff, Oshkosh, WI (US); Brent Radlinger, Oshkosh, WI (US); Caleb Binder, Oshkosh, WI (US)

(73) Assignee: Oshkosh Corporation, Oshkosh, WI (US)

(21) Appl. No.: 18/989,934

(22) Filed: Dec. 20, 2024

Related U.S. Application Data
(60) Provisional application No. 63/613,182, filed on Dec. 21, 2023.

(51) Int. Cl. B65F 3/04; B60R 16/03

(52) U.S. Cl. CPC B65F 3/046; B60R 16/03

(57) ABSTRACT

A method for operating a lift apparatus of a refuse vehicle includes receiving a user input from an operator of the refuse vehicle indicating a desired operating speed of the lift apparatus, operating at least one of an electric motor or an electric actuator to apply a first torque on the lift apparatus, acquiring, from one or more sensors, sensor data corresponding to movement of the lift apparatus, determining, based on the first torque and the sensor data, a weight of a refuse container engaged by the lift apparatus, determining, based on the weight of the refuse container and the desired operating speed, a second torque for the at least one of the electric motor of the electric actuator, the second torque higher than the first torque, and operating the at least one of the electric motor or the electric actuator to apply the second torque on the lift apparatus.

### CROSS-REFERENCE TO RELATED PATENT APPLICATION

This application claims the benefit of and priority to U.S. Provisional Patent Application No. 63/613,182, filed Dec. 21, 2023, which is incorporated herein by reference in its entirety.

### BACKGROUND

The present disclosure generally relates to the field of refuse vehicles. More specifically, the present disclosure relates to control systems for refuse vehicles.

### SUMMARY

One embodiment of the present disclosure relates to a refuse vehicle. The refuse vehicle includes a chassis, a body coupled to the chassis, a lift apparatus coupled to at least one of the chassis or the body and configured engage a refuse container to collect refuse stored within the refuse container, at least one of an electric motor or an electric actuator configured to drive the lift apparatus, one or more sensors configured to generate sensor data corresponding to movement of the lift apparatus, and one or more processing circuits. The one or more processing circuits are configured to receive a user input from an operator of the refuse vehicle indicating a desired operating speed of the lift apparatus, operate the at least one of the electric motor or the electric actuator to apply a first torque on a portion of the lift apparatus, acquire, from the one or more sensors, the sensor data, determine, based on the first torque and the sensor data, a weight of the refuse container engaged by the lift apparatus, determine, based on the weight of the refuse container and the desired operating speed, a second torque for the at least one of the electric motor or the electric actuator, and operate the at least one of the electric motor or the electric actuator to apply the second torque on the portion of the lift apparatus.

Another embodiment of the present disclosure relates to a refuse vehicle. The refuse vehicle includes a chassis, a body coupled to the chassis, a lift apparatus coupled to at least one of the chassis or the body and configured engage a refuse container to collect refuse stored within the refuse container, at least one of an electric motor or an electric actuator configured to drive the lift apparatus, one or more first sensors configured to generate first sensor data corresponding to the lift apparatus engaging the refuse container, one or more second sensors configured to generate second sensor data corresponding to movement of the lift apparatus, and one or more processing circuits. The one or more processing circuits are configured to acquire, from the one or more first sensors, the first sensor data, determine, based on the first sensor data, that the lift apparatus has engaged the refuse container, operate the at least one of the electric motor or the electric actuator to apply a first torque on a portion of the lift apparatus, acquire, from the one or more second sensors, the second sensor data, and determine, based on the first torque and the second sensor data, a weight of the refuse container.

Yet another embodiment of the present disclosure relates to a method for operating a lift apparatus of a refuse vehicle. The method includes receiving a user input from an operator of the refuse vehicle indicating a desired operating speed of the lift apparatus, operating at least one of an electric motor or an electric actuator of the refuse vehicle to apply a first torque on a portion of the lift apparatus, acquiring, from one or more sensors, sensor data corresponding to movement of the lift apparatus, determining, based on the first torque and the sensor data, a weight of a refuse container engaged by the lift apparatus, determining, based on the weight of the refuse container and the desired operating speed, a second torque for the at least one of the electric motor of the electric actuator, the second torque higher than the first torque, and operating the at least one of the electric motor or the electric actuator to apply the second torque on the portion of the lift apparatus.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a front-loading refuse vehicle, according to an exemplary embodiment;

FIG. 2 is a side view of a rear-loading refuse vehicle, according to an exemplary embodiment;

FIG. 3 is a perspective view of a side-loading refuse vehicle, according to an exemplary embodiment;

FIG. 4 is a block diagram of a control system for any of the refuse vehicles of FIGS. 1-3, according to an exemplary embodiment;

FIG. 5 is a diagram illustrating a collection route for autonomous transport and collection by any of the refuse vehicles of FIGS. 1-3, according to an exemplary embodiment;

FIG. 6 is a block diagram of a control system for operating a lift apparatus of any of the refuse vehicles of FIGS. 1-3, according to an exemplary embodiment;

FIG. 7 is a first diagram of a lift apparatus of the front-loading refuse vehicle of FIG. 1 that is operated by an actuator, according to an exemplary embodiment;

FIG. 8 is a second diagram of a lift apparatus of the front-loading refuse vehicle of FIG. 1 that is operated by an actuator, according to an exemplary embodiment;

FIG. 9 is a diagram of a fork of a lift apparatus of the front-loading refuse vehicle of FIG. 1 that is operated by an actuator, according to an exemplary embodiment;

FIG. 10 is a third diagram of a lift apparatus of the front-loading refuse vehicle of FIG. 1 that is operated by an actuator, according to an exemplary embodiment;

FIG. 11 is a fourth diagram of a lift apparatus of the front-loading refuse vehicle of FIG. 1 that is operated by an actuator, according to an exemplary embodiment;

FIG. 12 is a fifth diagram of a lift apparatus of the front-loading refuse vehicle of FIG. 1 that is operated by an actuator, according to an exemplary embodiment;

FIG. 13 is a sixth diagram of a lift apparatus of the front-loading refuse vehicle of FIG. 1 that is operated by an actuator, according to an exemplary embodiment;

FIG. 14 is a diagram of a lift apparatus of the side-loading refuse vehicle of FIG. 3, according to an exemplary embodiment;

FIG. 15 is a diagram of a lift apparatus of the front-loading refuse vehicle of FIG. 1 that is operated by an actuator, according to an exemplary embodiment;

FIG. 16 is a diagram of a lift apparatus of the front-loading refuse vehicle of FIG. 1 that is operated by a motor, according to an exemplary embodiment;

FIG. 17 is a graph of measured torque values while lowering and lifting a lift apparatus, according to an exemplary embodiment; and

FIG. 18 is a flow diagram for a process for operating for operating a lift apparatus of a refuse vehicle, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

### Refuse Vehicle

### Front-Loading Configuration

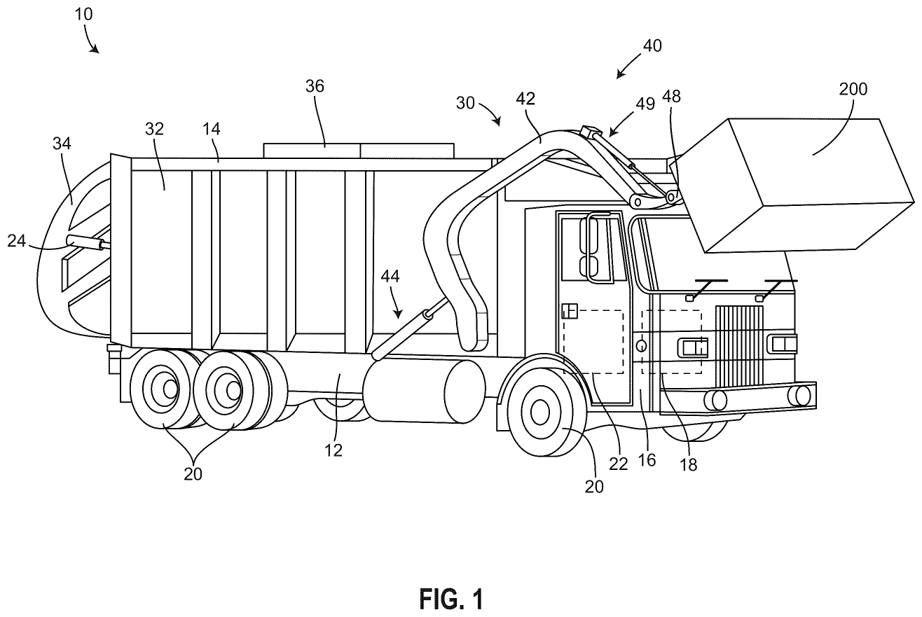

Referring to FIG. 1, a vehicle, shown as refuse vehicle 10 (e.g., a garbage truck, a waste collection truck, a sanitation truck, etc.), is shown that is configured to collect and store refuse along a collection route. In the embodiment of FIG. 1, the refuse vehicle 10 is configured as a front-loading refuse vehicle. The refuse vehicle 10 includes a chassis, shown as frame 12; a body assembly, shown as body 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator (e.g., a seat, a steering wheel, hydraulic controls, a user interface, an acceleration pedal, a brake pedal, a clutch pedal, a gear selector, switches, buttons, dials, etc.). As shown in FIG. 1, the refuse vehicle 10 includes a prime mover, shown as engine 18, coupled to the frame 12 at a position beneath the cab 16. The engine 18 is configured to provide power to tractive elements, shown as wheels 20, and/or to other systems of the refuse vehicle 10 (e.g., a pneumatic system, a hydraulic system, etc.). The engine 18 may be configured to utilize one or more of a variety of fuels (e.g., gasoline, diesel, bio-diesel, ethanol, natural gas, etc.), according to various exemplary embodiments. The fuel may be stored in a tank 28 (e.g., a vessel, a container, a capsule, etc.) that is fluidly coupled with the engine 18 through one or more fuel lines.

According to an alternative embodiment, the engine 18 additionally or alternatively includes one or more electric motors coupled to the frame 12 (e.g., a hybrid refuse vehicle, an electric refuse vehicle, etc.). The electric motors may consume electrical power from any of an on-board storage device (e.g., batteries, ultra-capacitors, etc.), from an on-board generator (e.g., an internal combustion engine, etc.), or from an external power source (e.g., overhead power lines, etc.) and provide power to the systems of the refuse vehicle 10. The engine 18 may transfer output torque to or drive the tractive elements 20 (e.g., wheels, wheel assemblies, etc.) of the refuse vehicle 10 through a transmission 22. The engine 18, the transmission 22, and one or more shafts, axles, gearboxes, etc., may define a driveline of the refuse vehicle 10.

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIG. 1, the body 14 includes a plurality of panels, shown as panels 32, a tailgate 34, and a cover 36. The panels 32, the tailgate 34, and the cover 36 define a collection chamber (e.g., hopper, etc.), shown as refuse compartment 30. Loose refuse may be placed into the refuse compartment 30 where it may thereafter be compacted. The refuse compartment 30 may provide temporary storage for refuse during transport to a waste disposal site and/or a recycling facility. In some embodiments, at least a portion of the body 14 and the refuse compartment 30 extend in front of the cab 16. According to the embodiment shown in FIG. 1, the body 14 and the refuse compartment 30 are positioned behind the cab 16. In some embodiments, the refuse compartment 30 includes a hopper volume and a storage volume. Refuse may be initially loaded into the hopper volume and thereafter transferred and/or compacted into the storage volume. According to an exemplary embodiment, the hopper volume is positioned forward of the cab 16 (e.g., refuse is loaded into a position of the refuse compartment 30 in front of the cab 16, a front-loading refuse vehicle, etc.). In other embodiments, the hopper volume is positioned between the storage volume and the cab 16 (e.g., refuse is loaded into a position of the refuse compartment 30 behind the cab 16 and stored in a position further toward the rear of the refuse compartment 30). In yet other embodiments, the storage volume is positioned between the hopper volume and the cab 16 (e.g., a rear-loading refuse vehicle, etc.).

The tailgate 34 may be hingedly or pivotally coupled with the body 14 at a rear end of the body 14 (e.g., opposite the cab 16). The tailgate 34 may be driven to rotate between an open position and a closed position by tailgate actuators 24. The refuse compartment 30 may be hingedly or pivotally coupled with the frame 12 such that the refuse compartment 30 can be driven to raise or lower while the tailgate 34 is open in order to dump contents of the refuse compartment 30 at a landfill. The refuse compartment 30 may include a packer assembly (e.g., a compaction apparatus) positioned therein that is configured to compact loose refuse.

Referring still to FIG. 1, the refuse vehicle 10 includes a first lift mechanism or system (e.g., a front-loading lift assembly, etc.), shown as lift assembly 40. The lift assembly 40 includes a pair of arms, shown as lift arms 42, coupled to at least one of the frame 12 or the body 14 on either side of the refuse vehicle 10 such that the lift arms 42 extend forward of the cab 16 (e.g., a front-loading refuse vehicle, etc.). The lift arms 42 may be rotatably coupled to the frame 12 with a first pivot (e.g., a lug, a shaft, etc.). The lift assembly 40 includes first actuators, shown as lift arm actuators 44 (e.g., hydraulic cylinders, etc.), coupled to the frame 12 and the lift arms 42. The lift arm actuators 44 are positioned such that extension and retraction thereof rotates the lift arms 42 about an axis extending through the first pivot, according to an exemplary embodiment. Lift arms 42 may be removably coupled to a container, shown as refuse container 200 in FIG. 1. Lift arms 42 are configured to be driven to pivot by lift arm actuators 44 to lift and empty the refuse container 200 into the hopper volume for compaction and storage. The lift arms 42 may be coupled with a pair of forks or elongated members, shown as forks 48 (e.g., engagement forks, prongs, etc.), that are configured to removably couple with the refuse container 200 so that the refuse container 200 can be lifted and emptied. The forks 48 may be rotatably coupled to the lift arms 42 with a second pivot (e.g., a lug, a shaft, etc.). The refuse container 200 may be similar to the container attachment 200 as described in greater detail in U.S. application Ser. No. 17/558,183, filed Dec. 12, 2021, the entire disclosure of which is incorporated by reference herein. The lift assembly 40 also includes second actuators, shown as fork actuators 49 (e.g., hydraulic cylinders, etc.), coupled to the lift arms 42 and the forks 48. The fork actuators 49 are positioned such that extension and retraction thereof rotates the forks 48 about an axis extending through the second pivot, according to an exemplary embodiment.

### Rear-Loading Configuration

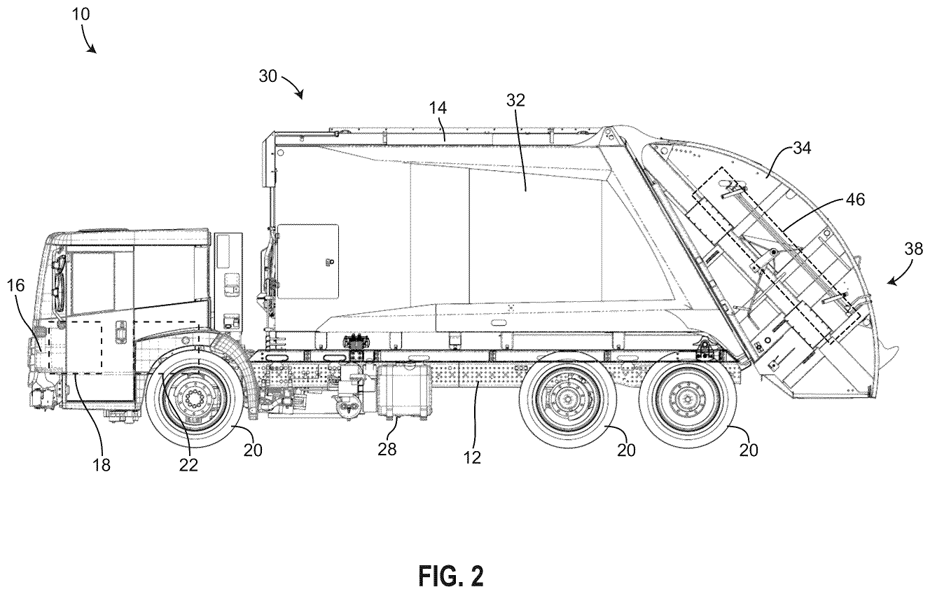

As shown in FIG. 2, the refuse vehicle 10 may be configured as a rear-loading refuse vehicle, according to some embodiments. In the rear-loading embodiment of the refuse vehicle 10, the tailgate 34 defines an opening 38 through which loose refuse may be loaded into the refuse compartment 30. The tailgate 34 may also include a packer 46 (e.g., a packing assembly, a compaction apparatus, a claw, a hinged member, etc.) that is configured to draw refuse into the refuse compartment 30 for storage. Similar to the embodiment of the refuse vehicle 10 described in FIG. 1 above, the tailgate 34 may be hingedly coupled with the refuse compartment 30 such that the tailgate 34 can be opened or closed during a dumping operation.

### Side-Loading Configuration

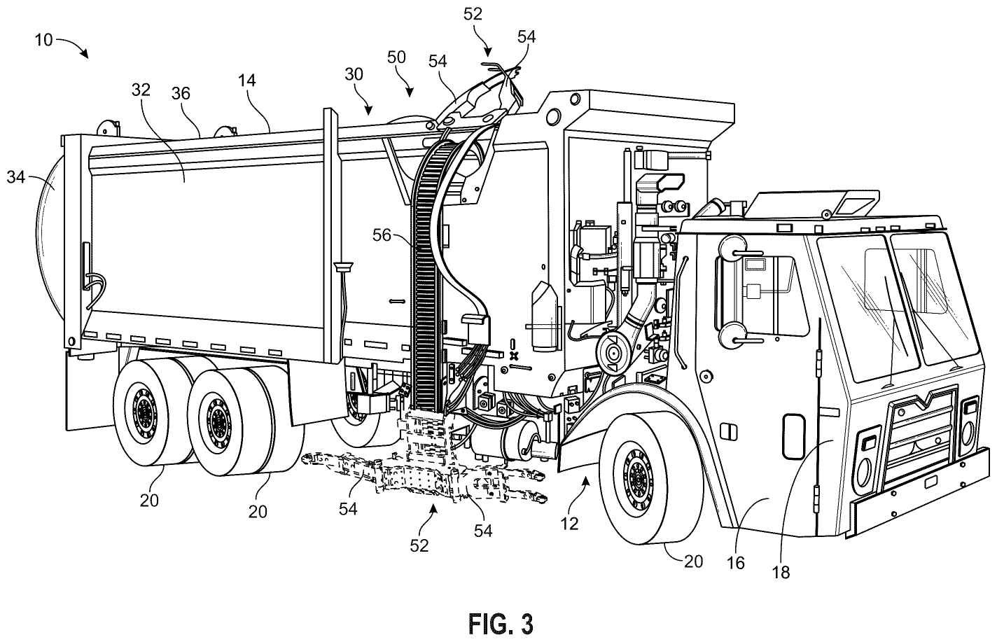

Referring to FIG. 3, the refuse vehicle 10 may be configured as a side-loading refuse vehicle (e.g., a zero radius side-loading refuse vehicle). The refuse vehicle 10 includes first lift mechanism or system, shown as lift assembly 50. Lift assembly 50 includes a grabber assembly, shown as grabber assembly 52, movably coupled to a track, shown as track 56, and configured to move along an entire length of track 56. According to the exemplary embodiment shown in FIG. 3, track 56 extends along substantially an entire height of body 14 and is configured to cause grabber assembly 52 to tilt near an upper height of body 14. In other embodiments, the track 56 extends along substantially an entire height of body 14 on a rear side of body 14. The refuse vehicle 10 can also include a reach system or assembly coupled with a body or frame of refuse vehicle 10 and lift assembly 50. The reach system can include telescoping members, a scissors stack, etc., or any other configuration that can extend or retract to provide additional reach of grabber assembly 52 for refuse collection.

Referring still to FIG. 3, grabber assembly 52 includes a pair of grabber arms shown as grabber arms 54. The grabber arms 54 are configured to rotate about an axis extending through a bushing. The grabber arms 54 are configured to releasably secure a refuse container to grabber assembly 52, according to an exemplary embodiment. The grabber arms 54 rotate about the axis extending through the bushing to transition between an engaged state (e.g., a fully grasped configuration, a fully grasped state, a partially grasped configuration, a partially grasped state) and a disengaged state (e.g., a fully open state or configuration, a fully released state/configuration, a partially open state or configuration, a partially released state/configuration). In the engaged state, the grabber arms 54 are rotated towards each other such that the refuse container is grasped therebetween. In the disengaged state, the grabber arms 54 rotate outwards such that the refuse container is not grasped therebetween. By transitioning between the engaged state and the disengaged state, the grabber assembly 52 releasably couples the refuse container with grabber assembly 52. The refuse vehicle 10 may pull up along-side the refuse container, such that the refuse container is positioned to be grasped by the grabber assembly 52 therebetween. The grabber assembly 52 may then transition into an engaged state to grasp the refuse container. After the refuse container has been securely grasped, the grabber assembly 52 may be transported along track 56 with the refuse container. When the grabber assembly 52 reaches the end of track 56, the grabber assembly 52 may tilt and empty the contents of the refuse container in refuse compartment 30. The tilting is facilitated by the path of the track 56. When the contents of the refuse container have been emptied into refuse compartment 30, the grabber assembly 52 may descend along the track 56, and return the refuse container to the ground. Once the refuse container has been placed on the ground, the grabber assembly may transition into the disengaged state, releasing the refuse container.

### Control System

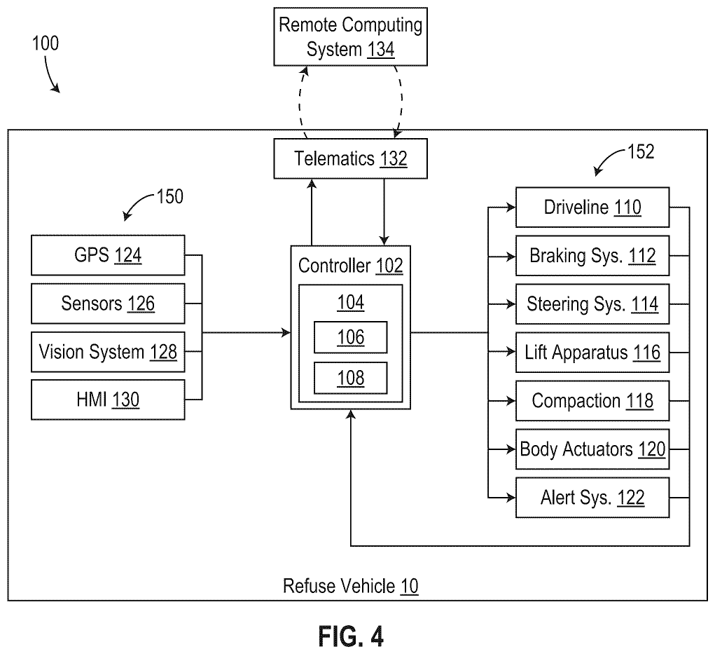

Referring to FIG. 4, the refuse vehicle 10 may include a control system 100 that is configured to facilitate autonomous or semi-autonomous operation of the refuse vehicle 10, or components thereof. The control system 100 includes a controller 102 that is positioned on the refuse vehicle 10, a remote computing system 134, a telematics unit 132, one or more input devices 150, and one or more controllable elements 152. The input devices 150 can include a Global Positioning System (“GPS”), multiple sensors 126, a vision system 128 (e.g., an awareness system), and a Human Machine Interface (“HMI”). The controllable elements 152 can include a driveline 110 of the refuse vehicle 10, a braking system 112 of the refuse vehicle 10, a steering system 114 of the refuse vehicle 10, a lift apparatus 116 (e.g., the lift assembly 40, the lift assembly 50, etc.), a compaction system 118 (e.g., a packer assembly, the packer 46, etc.), body actuators 120 (e.g., tailgate actuators 24, lift or dumping actuators, etc.), and/or an alert system 122.

The controller 102 includes processing circuitry 104 including a processor 106 and memory 108. Processing circuitry 104 can be communicably connected with a communications interface of controller 102 such that processing circuitry 104 and the various components thereof can send and receive data via the communications interface. Processor 106 can be implemented as a general purpose processor, an application specific integrated circuit (ASIC), one or more field programmable gate arrays (FPGAs), a group of processing components, or other suitable electronic processing components.

Memory 108 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 108 can be or include volatile memory or non-volatile memory. Memory 108 can include database components, object code components, script components, or any other type of information structure for supporting the various activities and information structures described in the present application. According to some embodiments, memory 108 is communicably connected to processor 106 via processing circuitry 104 and includes computer code for executing (e.g., by at least one of processing circuitry 104 or processor 106) one or more processes described herein.

The controller 102 is configured to receive inputs (e.g., measurements, detections, signals, sensor data, etc.) from the input devices 150, according to some embodiments. In particular, the controller 102 may receive a GPS location from the GPS system 124 (e.g., current latitude and longitude of the refuse vehicle 10). The controller 102 may receive sensor data (e.g., engine temperature, fuel levels, transmission control unit feedback, engine control unit feedback, speed of the refuse vehicle 10, etc.) from the sensors 126. The controller 102 may receive image data (e.g., real-time camera data) from the vision system 128 of an area of the refuse vehicle 10 (e.g., in front of the refuse vehicle 10, rearwards of the refuse vehicle 10, on a street-side or curb-side of the refuse vehicle 10, at the hopper of the refuse vehicle 10 to monitor refuse that is loaded, within the cab 16 of the refuse vehicle 10, etc.). The controller 102 may receive user inputs from the HMI 130 (e.g., button presses, requests to perform a lifting or loading operation, driving operations, steering operations, braking operations, etc.).

The controller 102 may be configured to provide control outputs (e.g., control decisions, control signals, etc.) to the driveline 110 (e.g., the engine 18, the transmission 22, the engine control unit, the transmission control unit, etc.) to operate the driveline 110 to transport the refuse vehicle 10. The controller 102 may also be configured to provide control outputs to the braking system 112 to activate and operate the braking system 112 to decelerate the refuse vehicle 10 (e.g., by activating a friction brake system, a regenerative braking system, etc.). The controller 102 may be configured to provide control outputs to the steering system 114 to operate the steering system 114 to rotate or turn at least two of the tractive elements 20 to steer the refuse vehicle 10. The controller 102 may also be configured to operate actuators or motors of the lift apparatus 116 (e.g., lift arm actuators 44) to perform a lifting operation (e.g., to grasp, lift, empty, and return a refuse container). The controller 102 may also be configured to operate the compaction system 118 to compact or pack refuse that is within the refuse compartment 30. The controller 102 may also be configured to operate the body actuators 120 to implement a dumping operation of refuse from the refuse compartment 30 (e.g., driving the refuse compartment 30 to rotate to dump refuse at a landfill). The controller 102 may also be configured to operate the alert system 122 (e.g., lights, speakers, display screens, etc.) to provide one or more aural or visual alerts to nearby individuals.

The controller 102 may also be configured to receive feedback from any of the driveline 110, the braking system 112, the steering system 114, the lift apparatus 116, the compaction system 118, the body actuators 120, or the alert system 122. The controller may provide any of the feedback to the remote computing system 134 via the telematics unit 132. The telematics unit 132 may include any wireless transceiver, cellular dongle, communications radios, antennas, etc., to establish wireless communication with the remote computing system 134. The telematics unit 132 may facilitate communications with telematics units 132 of nearby refuse vehicles 10 to thereby establish a mesh network of refuse vehicles 10.

The controller 102 is configured to use any of the inputs from any of the GPS system 124, the sensors 126, the vision system 128, or the HMI 130 to generate controls for the driveline 110, the braking system 112, the steering system 114, the lift apparatus 116, the compaction system 118, the body actuators 120, or the alert system 122. In some embodiments, the controller 102 is configured to operate the driveline 110, the braking system 112, the steering system 114, the lift apparatus 116, the compaction system 118, the body actuators 120, and/or the alert system 122 to autonomously transport the refuse vehicle 10 along a route (e.g., self-driving), perform pickups or refuse collection operations autonomously, and transport to a landfill to empty contents of the refuse compartment 30. The controller 102 may receive one or more inputs from the remote computing system 134 such as route data, indications of pickup locations along the route, route updates, customer information, pickup types, etc. The controller 102 may use the inputs from the remote computing system 134 to autonomously transport the refuse vehicle 10 along the route and/or to perform the various operations along the route (e.g., picking up and emptying refuse containers, providing alerts to nearby individuals, limiting pickup operations until an individual has moved out of the way, etc.).

In some embodiments, the remote computing system 134 is configured to interact with (e.g., control, monitor, etc.) the refuse vehicle 10 through a virtual refuse truck as described in U.S. application Ser. No. 16/789,962, now U.S. Pat. No. 11,380,145, filed Feb. 13, 2020, the entire disclosure of which is incorporated by reference herein. The remote computing system 134 may perform any of the route planning techniques as described in greater detail in U.S. application Ser. No. 18/111,137, filed Feb. 17, 2023, the entire disclosure of which is incorporated by reference herein. The remote computing system 134 may implement any route planning techniques based on data received by the controller 102. In some embodiments, the controller 102 is configured to implement any of the cart alignment techniques as described in U.S. application Ser. No. 18/242,224, filed Sep. 5, 2023, the entire disclosure of which is incorporated by reference herein. The refuse vehicle 10 and the remote computing system 134 may also operate or implement geofences as described in greater detail in U.S. application Ser. No. 17/232,855, filed Apr. 16, 2021, the entire disclosure of which is incorporated by reference herein.

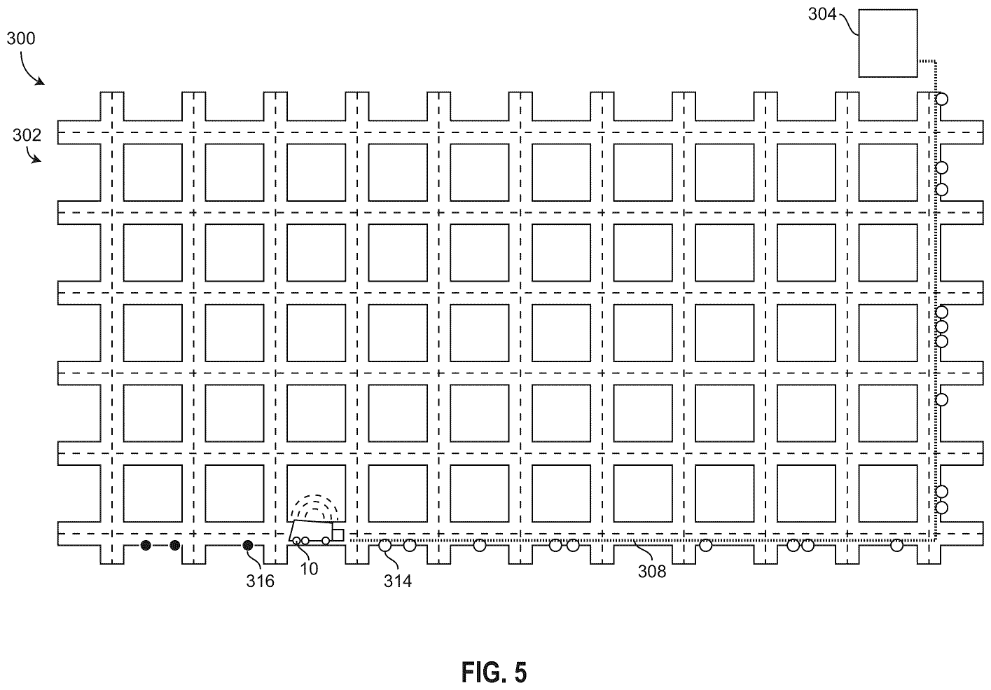

Referring to FIG. 5, a diagram 300 illustrates a route 308 through a neighborhood 302 for the refuse vehicle 10. The route 308 includes future stops 314 along the route 308 to be completed, and past stops 316 that have already been completed. The route 308 may be defined and provided by the remote computing system 134. The remote computing system 134 may also define or determine the future stops 314 and the past stops 316 along the route 308 and provide data regarding the geographic location of the future stops 314 and the past stops 316 to the controller 102 of the refuse vehicle 10. The refuse vehicle 10 may use the route data and the stops data to autonomously transport along the route 308 and perform refuse collection at each stop. The route 308 may end at a landfill 304 (e.g., an end location) where the refuse vehicle 10 may autonomously empty collected refuse, transport to a refueling location if necessary, and begin a new route.

### Control System for Lift Apparatus

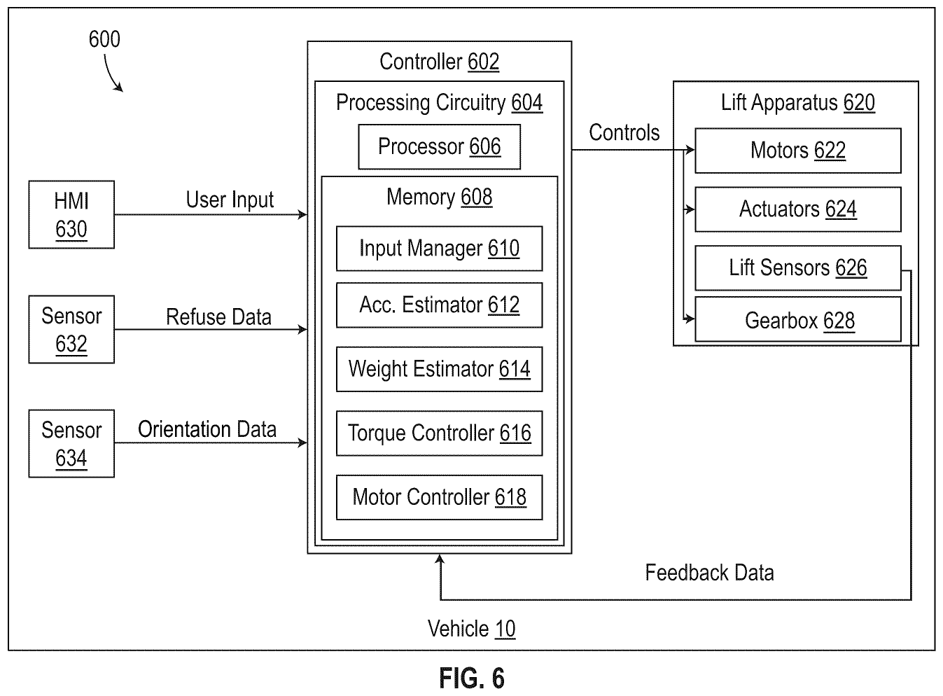

Referring to FIG. 6, the refuse vehicle 10 includes a control system 600 configured to operate a lift apparatus 620 of the refuse vehicle 10. In one embodiment, the lift apparatus 620 is a front-loading lift apparatus of the refuse vehicle 10 (e.g., the lift assembly 40). In another embodiment, the lift apparatus 620 is side-loading lift assembly (e.g., the lift assembly 50). In yet another embodiment, the lift apparatus 620 is a tailgate lift. In some embodiments, the lift apparatus 620 is an electric lift apparatus including one or more electric motors 622 and/or one or more electric actuators 624 (e.g., lead screw electric actuators, etc.). In some embodiments, the lift apparatus 620 includes both the electric motors 622 and the electric actuators 624. For example, the lift apparatus 620 may include the electric actuators 624 configured as lead screw actuators that are driven by the electric motors 622. In other embodiments, the lift apparatus 620 is a hydraulic lift apparatus having one or more hydraulic actuators. The control system 600 includes a controller 602 configured to operate the lift apparatus 620, according to some embodiments.

Many refuse vehicles utilize hydraulic systems in order to lift refuse containers into a storage volume of the refuse vehicle. When a hydraulic lift system needs to be operated faster, a hydraulic valve is opened which results in increased fluid flow to hydraulic components of the hydraulic lift system. The hydraulic lift systems can easily be adjusted in order to change a speed of the hydraulic lift system. Additionally, a joystick (e.g., part of the HMI 130) may be easily configured to operate the hydraulic valve. For example, an operator moving the joystick forward to a first position may open the hydraulic valve a first amount and cause the hydraulic lift system to operate at a first speed. When the operator moves the joystick forward to a second position that is further forward than the first position, the hydraulic valve may open a second amount and cause the hydraulic lift system to operate at a second speed that is faster than the first speed.

However, electric motors or electric actuators are typically operated in a torque-controlled manner, and therefore the speed of an electric lift apparatus changes as the counter-torque provided to the electric motors or actuators vary. When the lift apparatus 620 includes the electric motors 622 and/or the electric actuators 624, the counter-torque provided to the electric motors 622 and/or the electric actuators 624 from the lift apparatus 620 may change due to rotation of arms of the lift apparatus 620, different sized containers held by the lift apparatus 620, different amounts of refuse lifted by the arms of the lift apparatus 620, a position of arms of the lift apparatus 620, etc.

According to various embodiments described herein, the controller 602 is configured to use system dynamics (e.g., system kinematics, physical properties, etc.) of the lift apparatus 620 in order to estimate a load on the lift apparatus 620 (e.g., a mass of refuse, mass of the arms of the lift apparatus 620, an angle of inertia, friction in the lift apparatus 620, roll or angle of the refuse vehicle 10, etc.). The controller 602 is configured generate control signals for the electric motors 622 and/or the electric actuators 624 corresponding to output torques of the electric motors 622 and/or the electric actuators 624 applied on a portion of the lift apparatus 620 based on the load on the lift apparatus 620 in order to match a desired operating speed of the lift apparatus 620, according to some embodiments.

Additionally, it may be desired for the electric motors 622 and/or the electric actuators 624 of the refuse vehicle 10 to operate to meet minimum capacity requirements (e.g., a minimum capacity threshold, etc.) or cycle time requirements (e.g., a cycle time threshold, etc.) associated with the lift apparatus 620. For example, the lift arms 42 and the lift arm actuators 44 may be tested with a base load of 1300 pounds. The 1300 pounds may consist of a standard weight of the container 200 of 950 pounds and 350 pounds of refuse. The lift arm actuators 44 may be expected to be capable of lifting a maximum load of 8500 pounds on the lift arms 42, which may include the standard weight of the container 200 of 950 pounds and 7550 pounds of refuse. Under the base load, the lift arm actuators 44 may be expected to raise the lift arms 42 to a dump position (e.g., a position where the lift arms 42 dumps refuse into the compartment 30, etc.) in 6 seconds and lower back to a base position (e.g., a position where the lift arms 42 is configured to collect refuse, etc.) in 12 seconds. Under the base load, the fork actuators 49 may be expected to raise the forks 48 to an upward position (e.g., the forks 48 rotating upward relative to the lift arms 42, raise as part of a dump cycle, etc.) in 6 seconds and lower the forks 48 to a downward position (e.g., the forks 48 rotating downward relative to the lift arms 42, etc.) in 5 seconds. Under the maximum load, the lift arm actuators 44 may be expected to raise the lift arms 42 to the dump position in 9 seconds and lower the lift arms 42 to the base position in 18 seconds. Under the maximum load, the fork actuators 49 may be expected to raise the forks 48 to the upward position in 9 seconds and lower the forks 48 to the lower position in 8 seconds. The controller 602 may be configured to operate the electric motors 622 and/or the electric actuators 624 of the refuse vehicle 10 to meet the minimum load capacity requirements and/or the cycle time requirements. For example, the controller 602 may be configured to determine baseline operating parameters based on feedback data associated with operation of the lift apparatus 620 to operate the lift arm actuator 44 and/or the fork actuator 49 to meet the minimum load capacity requirements and/or the cycle time requirements.

Referring still to FIG. 6, the controller 602 may include processing circuitry 604 (e.g., one or more processing circuits, etc.) including a processor 606 and memory 608. Processing circuitry 604 can be communicably connected with a communications interface of controller 602 such that processing circuitry 604 and the various components thereof can send and receive data via the communications interface. Processor 606 can be implemented as a general purpose processor, an application specific integrated circuit (ASIC), one or more field programmable gate arrays (FPGAs), a group of processing components, or other suitable electronic processing components.

Memory 608 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 608 can be or include volatile memory or non-volatile memory. Memory 608 can include database components, object code components, script components, or any other type of information structure for supporting the various activities and information structures described in the present application. According to some embodiments, memory 608 is communicably connected to processor 606 via processing circuitry 604 and includes computer code for executing (e.g., by at least one of processing circuitry 604 or processor 606) one or more processes described herein.

The memory 608 of the controller 602 includes an input manager 610, an acceleration estimator 612, a weight estimator 614, a torque controller 616, and a motor controller 618, according to some embodiments. The controller 602 is configured to receive a user input from a human machine interface (HMI) 630 that indicates a requested control or operation of the lift apparatus 620. For example, the controller 602 may receive a user input from a joystick of the HMI 630. In some embodiments, the HMI 630 may be configured as HMI 130.

The controller 602 is configured to receive refuse data from a refuse sensor 632 (e.g., a lift apparatus sensor, etc.) indicating a refuse weight and/or a weight of the refuse container 200 that is currently received by the lift apparatus 620, according to some embodiments, and to control the lift apparatus 620 based on refuse data. In some embodiments, the refuse sensor 632 is at least one of the sensors 126. In some embodiments, the refuse sensor 632 is a strain gauge positioned at pins of the lift apparatus 620 and configured to measure pin stress at pins of the lift apparatus 620. For example, the refuse sensor 632 may measure pin stress at the pins of the lift apparatus 620 which may be directly related to overall weight of the refuse container 200 (e.g., a sum of the weight of the refuse container 200 and the refuse weight contained within the refuse container 200, etc.). In other embodiments, the refuse sensor 632 is another sensor type that is configured to generate and provide engagement data indicative that the lift apparatus 620 has engaged the refuse container 200.

The controller 602 is configured to receive orientation data from an orientation sensor 634 indicating an orientation of the vehicle 10, according to some embodiments. In some embodiments, the orientation sensor 634 is at least one of the sensors 126 and/or the GPS 124. The orientation sensor 634 may be a GPS sensor positioned on the vehicle 10 configured to determine a location and/or a position of the vehicle 10. In some embodiments, the orientation sensor 634 is an accelerometer that measures an acceleration and/or a velocity of the vehicle 10. In some embodiments, the orientation sensor 634 is a tilt sensor configured to measure an incline of the vehicle 10.

The controller 602 is configured to receive feedback data from a lift sensor 626 relating to the operation of the lift apparatus 620, according to some embodiments. In some embodiments, the lift sensor 626 is at least one of the sensors 126. In some embodiments, the lift apparatus 620 includes the lift sensor 626. In other embodiments, the lift sensor 626 is positioned remote of the lift apparatus 620. In some embodiments, the controller 602 is configured to receive feedback data from the lift sensor 626 indicating an operation of the of the lift apparatus 620. For example, the lift sensor 626 may generate feedback data corresponding to a position and/or a movement of the lift apparatus 620. In some embodiments, the lift sensor 626 is a linear variable differential transformer (LVDT) that is coupled to the electric motors 622 and/or the electric actuators 624 of the lift apparatus 620. For example, the LVDT may be configured to measure a linear displacement of the electric actuators 624. The feedback data generated by the LVDT may not be directly related to the overall weight of the refuse container 200. In some embodiments, the lift sensor 626 may be configured to measure a linear compression and/or a linear displacement of a spring of the electric actuators 624. In some embodiments, the lift sensor 626 may be a rotation sensor configured to measure a rotational displacement of the electric motors 622 and/or the electric actuators 624. For example, the lift sensor 626 may be an encoder positioned on the electric motors 622 configured to measure a number of rotations of the electric motors 622. In some embodiments, the lift sensor 626 may be an accelerometer positioned on the lift apparatus 620 and/or positioned on the refuse container 200 and configured to measure an acceleration and/or a velocity of the lift apparatus 620 or the refuse container 200. For example, the lift sensor 626 may measure an acceleration of the refuse container 200 in response to a torque applied by the electric motors 622 and/or the electric actuators 624 on the portion of the lift apparatus 620. In some embodiments, the lift sensor 626 may be configured to measure an angular acceleration and/or an angular velocity of the lift apparatus 620 and/or the refuse container 200.

The input manager 610 is configured to receive various inputs from data sources. In particular, the input manager 610 may receive the user input from the HMI 630, the refuse data from the refuse sensor 632, the orientation data from the orientation sensor 634, and the feedback data from the lift sensor 626, according to some embodiments. In some embodiments, the input manager 610 is configured to receive the various inputs from the data sources wirelessly. For example, the input manager 610 may wirelessly (e.g., through Bluetooth, through a wireless network, through a LAN network, etc.) communicate with the lift sensor 626 to receive the feedback data from the lift sensor. In some embodiments, the input manager 610 is configured to provide any of the various inputs to a remote computing system. The input manager 610 may include any wireless transceiver, cellular dongle, communications radios, antennas, etc., to establish wireless communication with the remote computing system.

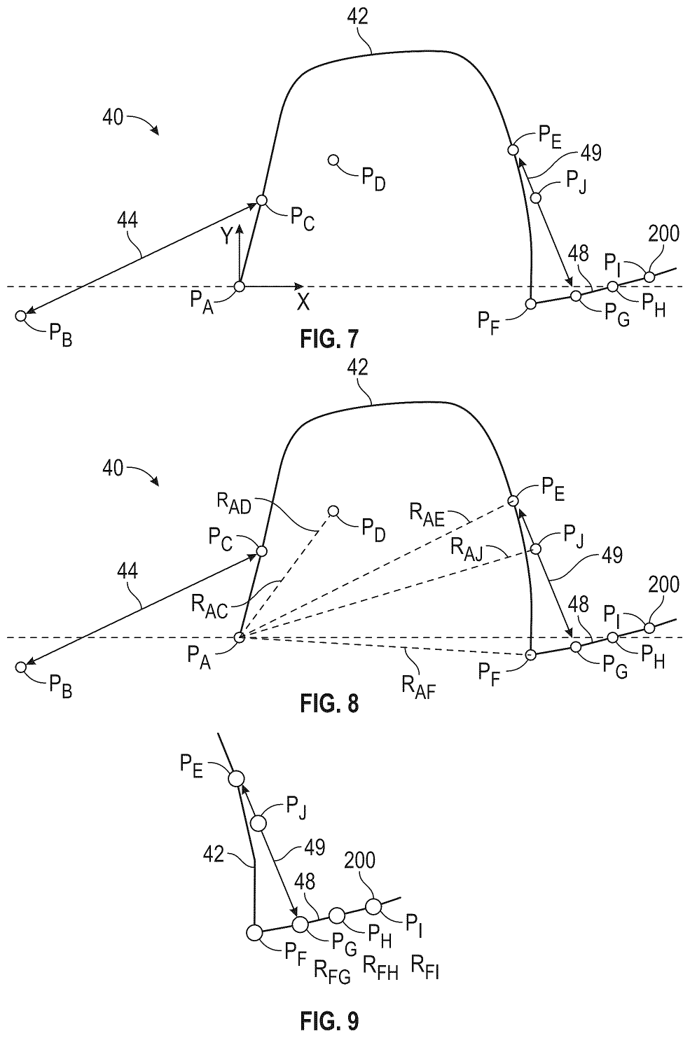

Referring to FIG. 7, the acceleration estimator 612 is configured to determine kinematic relationships (e.g., geometric relationships, etc.) of the components of the lift apparatus 620, according to some embodiments. For example, the acceleration estimator 612 may utilize kinematic diagrams of the lift apparatus 620 to determine kinematic relationships between components of the lift apparatus 620 and locations of the components of the lift apparatus 620. According to the exemplary embodiment shown in FIG. 7, the acceleration estimator 612 is configured to determine the kinematic relationships of the lift assembly 40. The acceleration estimator 612 starts with a model of the lift assembly 40 including one of the lift arms 42, one of the lift arm actuators 44, one of the forks 48, and one of the fork actuators 49. Notable points in the model of the lift assembly 40 are shown in Table 1 below:

TABLE 1

| Point | Description |
|---|---|
| P_{A} | Arm Pivot Point |
| P_{B} | Arm Actuator |
| | Body Mount |
| P_{C} | Arm Actuator Arm |
| | Mount |
| P_{D} | Arm Mass Center |
| | of Gravity |
| P_{E} | Fork Actuator |
| P_{F} | Fork Pivot Point |
| P_{G} | Fork Actuator |
| | Fork Mount |
| P_{H} | Fork Center of |
| | Gravity |
| P_{I} | Refuse Center of |
| | Gravity |
| P_{J} | Fork Actuator |
| | Center of Gravity |

The acceleration estimator 612 may track the movement of each point listed in the Table 1 relative to the first pivot of the lift arm 42, which may be used to calculate a torque associated with a mass of each of the components of the lift assembly 40. For example, the input manager 610 may track the movement of each of the points listed in Table 1 relative to the Arm Pivot Point P_{A}. In various embodiments, the acceleration estimator 612 determines the positions of the lift apparatus 620 based on known geometries of the lift apparatus 620.

Referring to FIG. 8, the acceleration estimator 612 is configured to utilize the kinematic relationships of the components of the lift apparatus 620 to determine substantially constant radii between a first pivot point of a first component of the lift apparatus 620 and other points of the lift apparatus 620 associated with the first component, according to some embodiments. According to the exemplary embodiment shown in FIG. 8, the acceleration estimator 612 utilizes the kinematic relationships of the components of the lift assembly 40 to determine radii from the Arm Pivot Point P_{A} of the lift arms 42 of the lift assembly 40 to other points of the lift assembly 40 associated with the lift arms 42, according to some embodiments. For example, the radii from the Arm Pivot Point P_{A} to other points of the lift assembly 40 may be constant or substantially constant due to fixed relationships between the components of the lift assembly 40. Examples of constant radii from the Arm Pivot Point P_{A} to other points of the lift assembly 40 are shown in Table 2 below:

TABLE 2

| Radius | Description |
|---|---|
| R_{AC} | Arm Pivot to Arm |
| | Actuator Arm |
| | Mount |
| R_{AD} | Arm Pivot to Arm |
| | Center of Gravity |
| R_{AE} | Arm Pivot to Fork |
| | Actuator Arm |
| | Mount |
| R_{AF} | Arm Pivot to Fork |
| | Pivot |
| R_{AJ} | Arm Pivot to Fork |
| | Actuator |

Referring to FIG. 9, the acceleration estimator 612 is configured to utilize the kinematic relationships of the components of the lift apparatus 620 to determine substantially constant radii between a second pivot point of a second component of the lift apparatus 620 pivotably coupled to the first component of the lift apparatus 620 and other points of the lift apparatus 620 associated with the second component of the lift apparatus 620, according to some embodiments. According to the exemplary embodiment shown in FIG. 9, the acceleration estimator 612 utilizes the kinematic relationships of the components of the lift assembly 40 to determine radii from the Fork Pivot Point P_{F} where the forks 48 are pivotably coupled to the lift arms 42 to other points of the lift assembly 40 associated with the forks 48, according to some embodiments. For example, the radii from the Fork Pivot Point P_{F} to other points of the lift assembly 40 associated with the forks 48 may include radii to points along the forks 48 and/or points associated with the refuse container 200 engaged by the forks 48. The radii from the Fork Pivot Point P_{F} to other points of the lift assembly 40 associated with the forks 48 may be substantially constant due to fixed relationships between the components of the lift assembly 40. Examples of constant radii from the Fork Pivot Point P_{F} to other points of the lift assembly 40 are shown in Table 3 below:

TABLE 3

| Radius | Description |
|---|---|
| R_{FG} | Fork Pivot to Fork |
| | Actuator Fork |
| | Mount |
| R_{FH} | Fork Pivot to Fork |
| | Center of Gravity |
| R_{FI} | Fork Pivot to |
| | Refuse Center of |
| | Gravity |

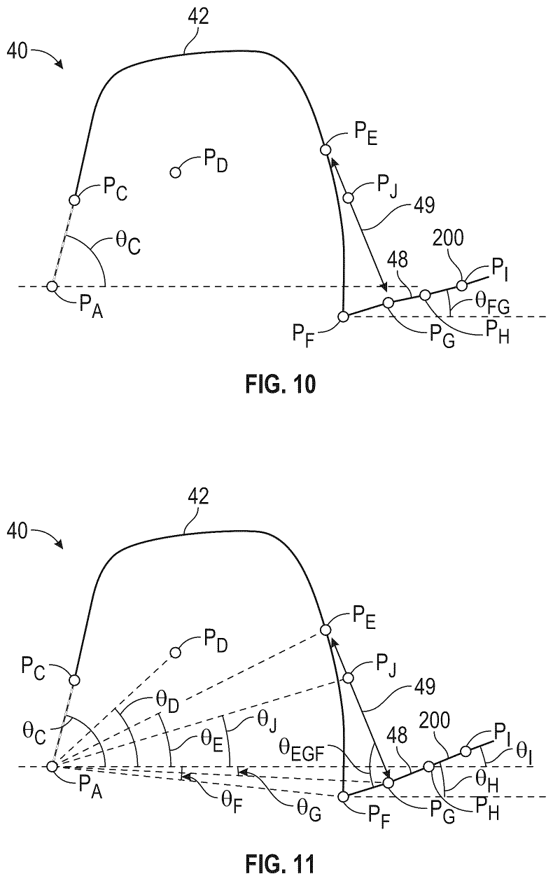

Referring to FIG. 10, the acceleration estimator 612 is configured to utilize the kinematic relationships of the components of the lift apparatus 620 to determine initial angles associated with the components of the lift apparatus 620. According to the exemplary embodiment shown in FIG. 10, the acceleration estimator 612 is configured to utilize the kinematic relationships of the components of the lift assembly 40 to determine initial angles associated with the components of the lift assembly 40. The kinematic relationships may be based on configurations of the lift arm actuators 44 and/or the fork actuators 49. For example, the acceleration estimator 612 may determine an initial angle θ_{C} of the lift arm 42 relative to a horizontal based on a configuration of the lift arm actuators 44 determined using the feedback data from the lift sensors 626 corresponding to the configuration of the lift arm actuators 44 (e.g., an extension distance of the lift arm actuators 44, a retraction distance of the lift arm actuators 44, etc.). As another example, the acceleration estimator 612 may determine an initial angle θ_{FG} of the fork 48 relative to a horizontal based on a configuration of the fork actuators 49 determined using the feedback data from the lift sensors 626 corresponding to the configuration of the fork actuators 49 (e.g., an extension distance of the fork actuators 49, a retraction distance of the fork actuators 49, etc.). Examples of the initial angles associated with the components of the lift assembly 40 are shown in Table 4 below:

TABLE 4

| Point | Description |
|---|---|
| θ_{C} | Arm Initial Angle |
| θ_{FG} | Fork Initial Angle |

Referring to FIG. 11, the acceleration estimator 612 is configured to determine angle offsets of radii between the first pivot point of the first component of the lift apparatus 620 and the other points of the lift apparatus 620 (e.g., the other points of the lift apparatus 620 associated with the first component, the other points of the lift apparatus 620 associated with the second component, etc.) relative to a horizontal based on the kinematic relationships of the lift apparatus 620 and/or the radii between the points of the lift apparatus 620. According to the exemplary embodiment shown in FIG. 11, the acceleration estimator 612 is configured to determine angle offsets of radii between the Arm Pivot Point P_{A} of the lift assembly 40 and the other points of the lift assembly 40 relative to a horizontal based on the kinematic relationships of the lift assembly 40 and/or the radii between the points of the lift assembly 40. Examples of the angle offsets of the radii between the Arm Pivot Point P_{A} of the lift assembly 40 and the other points of the lift assembly 40 relative to the horizontal, with exception of θ_{EGF} which is between the fork 48 and the fork actuators 49 are shown in Table 5 below:

TABLE 5

| Point | Description |
|---|---|
| θ_{C} | Arm Actuator Arm |
| | Mount Angle |
| θ_{D} | Arm Center of |
| | Gravity Ange |
| θ_{E} | Fork Actuator Arm |
| | Mount Angle |
| θ_{F} | Fork Pivot Point |
| | Angle |
| θ_{G} | Fork Actuator |
| | Fork Mount Angle |
| θ_{H} | Fork Center of |
| | Gravity Angle |
| θ_{I} | Refuse and |
| | Container Point |
| | Mass Angle |
| θ_{I} | Fork Actuator |
| | Center of Gravity |
| | Angle |
| θ_{EGF} | Fork Actuator |
| | Angle |

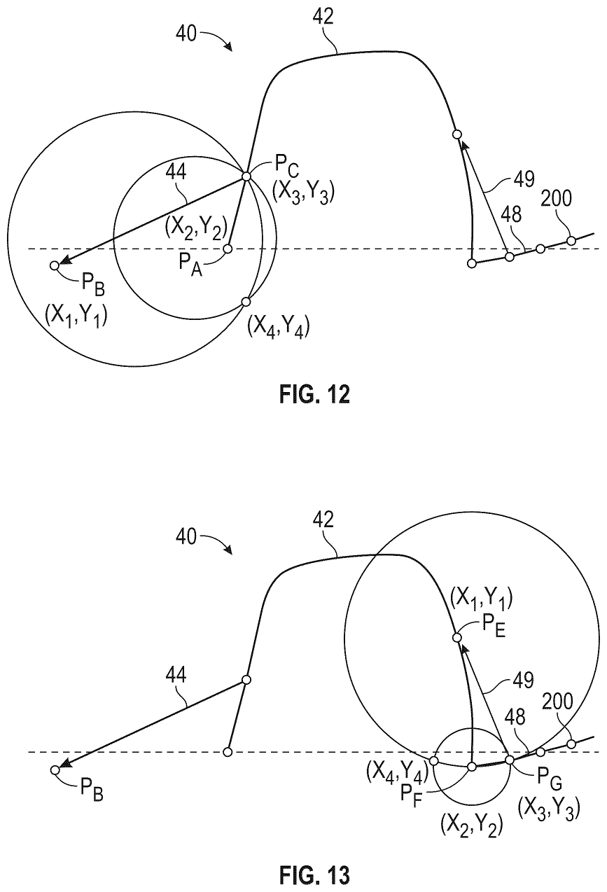

Referring to FIGS. 12 and 13, the acceleration estimator 612 is configured to utilize an intersection of two circles to determine locations of the points of the lift apparatus 620. According to the exemplary embodiment shown in FIGS. 12 and 13, the acceleration estimator 612 is configured to utilize the intersection of two circles to determine a location of the arm actuator mount P_{C} of the lift assembly 40 and/or a location of the fork actuator fork mount P_{G} of the lift assembly 40. For example, the acceleration estimator 612 may utilize mathematical equations or computer models corresponding with the two circles shown in FIG. 12 to determine the location of the arm actuator mount P_{C} and/or the location of the fork actuator fork mount P_{G}.

The acceleration estimator 612 is configured to estimate an acceleration of a component of the lift apparatus 620 (e.g., the lift arms 42, the grabber assembly 52, the refuse container 200, the tailgate lifter, etc.), according to some embodiments. For example, the electric motors 622 or the electric actuators 624 may apply an initial torque (e.g., a first torque, etc.) on a portion of the lift apparatus 620, resulting in motion of at least one of the components of the lift apparatus 620. The lift sensor 626 may generate the feedback data corresponding to the motion of the at least one component of the lift apparatus 620. The acceleration estimator 612 may determine the acceleration of the at least one component of the lift apparatus 620 based on the feedback data generated by the lift sensor 626. In some embodiments, the lift sensor 626 measures the acceleration of the component of the lift apparatus 620 and the acceleration estimator 612 receives the acceleration of the component of the lift apparatus 620 from the lift sensor 626.

In some embodiments, the acceleration estimator 612 is configured to determine the acceleration of the at least one component of the lift apparatus 620 using the various inputs from the data sources received by the input manager 610. For example, the vehicle 10 may be driving in a forward direction when the electric motors 622 and/or the electric actuators 624 applies the initial torque on the portion of the lift apparatus 620. The acceleration estimator 612 may utilize the orientation data received from the orientation sensor 634 to determine a vehicle acceleration of an entirety of the vehicle 10 and subtract the vehicle acceleration from a feedback acceleration received from the lift sensor 626 to determine an acceleration of the at least one of the components of the lift apparatus 620 caused by the initial torque applied by the electric motors 622 or the electric actuators 624 on the portion of the lift apparatus 620 that does not include an acceleration component from the vehicle acceleration of the vehicle 10.

In some embodiments, the acceleration estimator 612 utilizes a displacement of the electric motors 622 and/or the electric actuators 624 received from the lift sensor 626 to determine the acceleration and/or the angular acceleration of the at least one component of the lift apparatus 620. As described in more detail herein, the acceleration estimator 612 may utilize the kinematic relationships of the vehicle 10, the lift apparatus 620, the components of the lift apparatus 620, and the refuse container 200 to determine the acceleration and/or the angular acceleration of the component of the lift apparatus 620 using the displacement of the electric motors 622 and/or the electric actuators 624. For example, the acceleration estimator 612 may receive linear displacement data of the electric actuators 624 from the lift sensor 626 that takes place over a first time period. The acceleration estimator 612 may determine linear velocity data of the electric actuators 624 by differentiating the linear displacement data with respect to time and may further determine linear acceleration data of the electric actuators 624 by differentiating the linear velocity data with respect to time. As another example, the acceleration estimator 612 may receive rotational displacement data of the electric motors 622 from the lift sensor 626 that takes place over a first time period. The acceleration estimator 612 may determine angular velocity data of the electric motors 622 by differentiating the angular displacement data with respect to time and may further determine angular acceleration data of the electric motors 622 by differentiating the rotational velocity data with respect to time. In some embodiments, the acceleration estimator 612 utilizes a low pass filter to reduce noise and inaccurate calculations.

After the acceleration estimator 612 has determined the linear acceleration data of the electric actuators 624 and/or the angular acceleration of the electric motors 622, the acceleration estimator 612 may utilize the kinematic relationships of the vehicle 10 to determine the acceleration and/or the angular acceleration of the at least one component of the lift apparatus 620. For example, the acceleration estimator 612 may determine that if the electric motors 622 has a first angular acceleration, the at least one component of the lift apparatus 620 will have a second angular acceleration due to the kinematic relationships between the electric motors 622 and the at least one component of the lift apparatus 620. As another example, the acceleration estimator 612 may determine that if the electric actuators 624 has a first linear acceleration, the at least one component of the lift apparatus 620 will have a second linear acceleration due to the kinematic relationships between the electric actuators 624 and the component of the lift apparatus 620. In some embodiments, the acceleration estimator 612 may utilize an angular acceleration of the electric motors 622 to determine a linear acceleration of the at least one component of the lift apparatus 620 and/or the acceleration estimator 612 may utilize a linear acceleration of the electric actuators 624 to determine an angular acceleration of the at least one component of the lift apparatus 620.

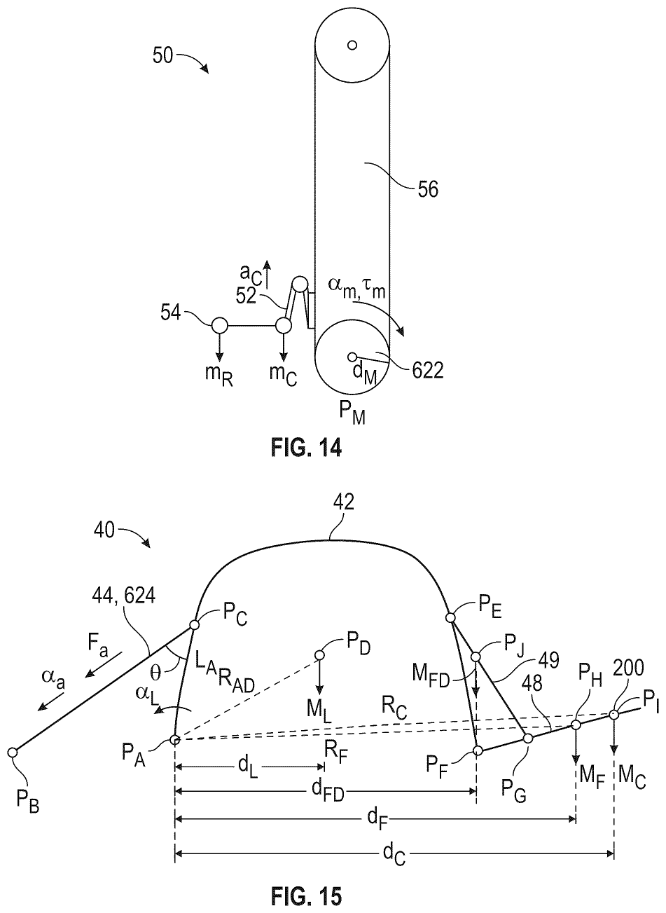

According to the exemplary embodiment shown in FIG. 14, the acceleration estimator 612 is configured to determine the linear acceleration of the grabber assembly 52 of the lift assembly 50. The lift assembly 50 may be operated along the track 56 by the electric motors 622. The acceleration estimator 612 may receive the feedback data from the lift sensor 626 associated with the electric motors 622 and then determine an angular acceleration am of the electric motors 622 around a center point P_{M} based on the feedback data. The acceleration estimator 612 may then determine a linear acceleration a_{c} of the grabber assembly 52 based on the kinematic relationship between the electric motors 622 and the grabber assembly 52. For example, the kinematic relationship may be that for every rotation of the electric motors 622, the grabber assembly 52 travels a certain distance along the track 56.

According to the exemplary embodiment shown in FIG. 15, the acceleration estimator 612 is configured to determine the angular acceleration of the lift arms 42 of the lift assembly 40. The lift assembly 40 may be rotated relative to the vehicle 10 by the electric actuators 624 (e.g., the lift arm actuators 44). The acceleration estimator 612 may receive the feedback data from the lift sensor 626 associated with the electric actuators 624 and then determine a linear acceleration aa of the electric actuators 624 based on the feedback data. The acceleration estimator 612 may then determine an angular acceleration am of the lift arms 42 around Arm Pivot Point P_{A} based on the kinematic relationship between the electric actuators 624 and the lift arms 42. For example, the kinematic relationship may include a location where the electric actuators 624 is coupled to the lift arms 42, an angle between the electric actuators 624 and the lift arms 42, a length and profile of the lift arms 42, etc. In embodiments where the lift arms 42 are removably coupled to the refuse container 200, the acceleration estimator 612 may be configured to determine the angular acceleration of the refuse container 200 based on the kinematic relationship between the electric actuators 624 and the refuse container 200. For example, the position of the refuse container 200 when the refuse container 200 is engaged with the lift assembly 40 may be known by the acceleration estimator. In various embodiments, the acceleration estimator 612 may be configured to determine the angular acceleration of the forks 48 of the lift arms 42 of the lift assembly 40 (e.g., the forks 48 configured to engage the refuse container 200, etc.) which may be rotated relative to the lift arms 42 by the electric motors 622 or the electric actuators 624 using similar calculations to the calculations described above in relation to the lift arms 42.

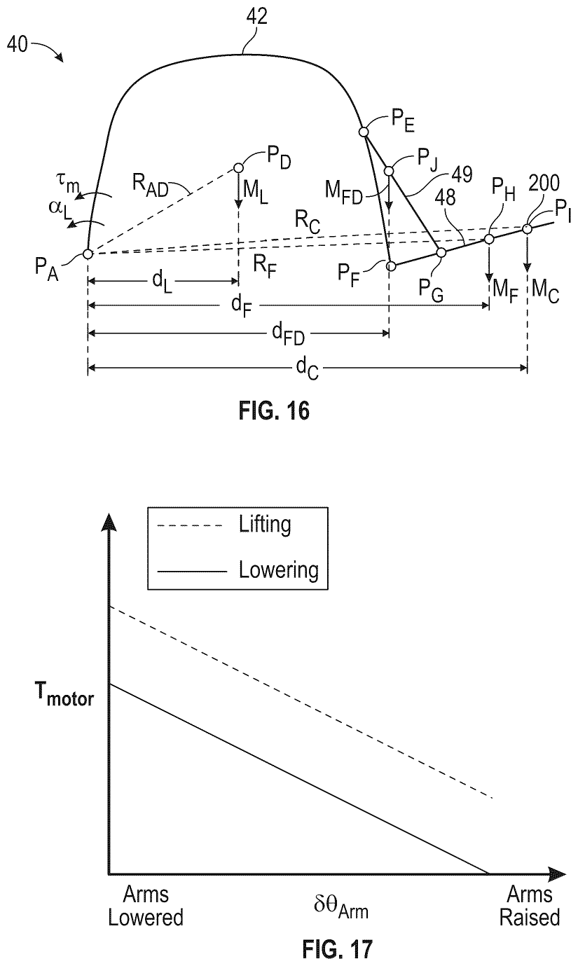

According to the exemplary embodiment shown in FIG. 16, the acceleration estimator 612 may be configured to determine the angular acceleration of the lift arms 42 of the lift assembly 40. The lift assembly 40 may be rotated relative to the vehicle 10 by the electric motors 622. The acceleration estimator 612 may receive the feedback data from the lift sensor 626 associated with the electric motors 622 and then determine an angular acceleration am of the electric motors 622 around point P_{A} based on the feedback data. The acceleration estimator 612 may then determine an angular acceleration au of the lift arms 42 around the point P_{A} based on the kinematic relationship between the electric motors 622 and the lift arms 42. For example, the electric motors 622 may be geared to the lift arms 42 at a ratio of 3 to 1, so the angular acceleration am of the electric motors 622 may be three times greater than the angular acceleration au of the lift arms 42. In embodiments where the lift arms 42 are removably coupled to the refuse container 200, the acceleration estimator 612 may be configured to determine the angular acceleration of the refuse container 200 based on the kinematic relationship between the electric motors 622 and the refuse container 200.

The weight estimator 614 is configured to estimate a load on the lift apparatus 620, according to some embodiments. In some embodiments, the load on the lift apparatus 620 is the weight of the lift apparatus 620 and the refuse weight being handled by the lift apparatus 620. In some embodiments, the weight of the lift apparatus 620 is known by the weight estimator 614, so the weight estimator 614 only determines the refuse weight being handled by the lift apparatus 620. In some embodiments, the weight estimator 614 estimates the weight of the lift apparatus 620 and the refuse weight being handled by the lift apparatus 620 based on the linear acceleration or the angular acceleration determined by the acceleration estimator 612. For example, the electric actuators 624 may apply a torque on a portion of the lift apparatus 620 and the weight estimator 614 may estimate the refuse weight being handled by the lift apparatus 620 based on the angular acceleration of the component of the lift apparatus 620 determined by the acceleration estimator 612 and the torque applied by the electric actuators 624 on the portion of the lift apparatus 620 provided by the torque controller 616 or the motor controller 618. In some embodiments, the weight estimator 614 may utilize dynamic equations and known component properties (e.g., a mass of the lift assembly 40, a mass of the lift arms 42, a mass of the lift assembly 50, a mass of the container 200, etc.) to estimate the weights. For example, a weight of the refuse container 200 that is engaged by the lift apparatus 620 may be known by the weight estimator 614. As another example, a distance from a pivot of the lift apparatus 620 to an engagement point of the lift apparatus 620 where the lift apparatus 620 engages the refuse container 200 may be known by the weight estimator 614.

In some embodiments, the weight estimator 614 is configured to adjust the dynamic equations and the known component properties based on the electric motors 622 or the electric actuators 624 adjusting a position of the component of the lift apparatus 620. For example, when the electric actuators 624 is actuated to change the position of the component of the lift apparatus 620, an angle between the electric actuators 624 and the component of the lift apparatus 620 may be modified. The weight estimator 614 is configured to modify the known component properties to adjust for the modification of the angle such that the weight estimator 614 can accurately estimate the weight of the lift apparatus 620 and the refuse weight being handled by the lift apparatus 620 throughout a range of motions of the lift apparatus 620.

Referring to FIG. 14, the weight estimator 614 may be configured to determine a refuse weight held by the lift assembly 50. For example, the weight estimator 614 may receive the linear acceleration a_{c} of the grabber assembly 52 along the track 56 from the acceleration estimator 612 and a torque τₘ applied by the electric motors 622 on the portion of the lift apparatus 620 from the torque controller 616 or the motor controller 618. Additionally, the weight estimator 614 may know the acceleration due to gravity g, a first mass m_{c} of the grabber assembly 52 and a diameter d of a driver of the electric motors 622 configured to drive the grabber assembly 52 along the track 56. Based on this information, the weight estimator 614 may estimate the refuse weight mᵣ held by the lift assembly 50 by solving the equation below for mᵣ and multiplying mᵣ by g:

$${a}_{c} ( {m}_{r} + {m}_{c} ) = {τ}_{m} \times d - g ( {m}_{r} + {m}_{c} )$$

Referring to FIG. 15, the weight estimator 614 may be configured to determine a refuse weight held by the refuse container 200 engaged by the lift assembly 40 that is operated by the electric actuators 624. For example, the weight estimator 614 may receive the angular acceleration α_{L} of the lift arms 42 around the arm pivot point P_{A} from the acceleration estimator 612 and a force Fₐ applied by the electric actuators 624 from the torque controller 616 or the motor controller 618. The force Fₐ may be considered to a torque applied by the electric actuators 624 on the lift arms 42 about the arm pivot point P_{A} by multiplying the force Fₐ by a length La between the arm pivot point P_{A} and the arm actuator arm mount P_{C} where the electric actuators 624 is coupled to the lift arms 42 and a sine of an angle θ between the electric actuators 624 and the lift arms 42. The weight estimator 614 may know the acceleration due to gravity g, the length La between the arm pivot point P_{A} and the arm actuator arm mount P_{C} where the electric actuators 624 is coupled to the lift arms 42, the angle θ between the electric actuators 624 and the lift arms 42, a mass my of the lift arms 42, a horizontal distance d_{L} between the arm pivot point P_{A} and the center of mass of the lift arms 42, the distance R_{AD} between the arm pivot point P_{A} and the center of mass of the lift arms 42, a moment of inertia I_{L} of the lift arms 42, a mass me of the refuse container 200, a horizontal distance d_{c} between the arm pivot point P_{A} and the center of mass of the refuse container 200, a distance R_{c} between the arm pivot point P_{A} and the center of mass of refuse container 200, a horizontal distance d_{R} between the arm pivot point P_{A} and the center of mass of the refuse, a distance R_{R} between the arm pivot point P_{A} and the center of mass of refuse, a mass m_{FD} of the fork actuator 49, a horizontal distance d_{FD} between the arm pivot point P_{A} and a center of mass of the fork actuator 49, a distance R_{FD} between the arm pivot point P_{A} and the center of mass of the fork actuator 49, and a moment of inertia I_{FD} of the fork actuator 49. Based on this information, the weight estimator 614 may estimate the refuse weight mᵣ held by the lift assembly 50 by solving the equation below for m_{R} and multiplying mᵣ by g:

$${F}_{a} {L}_{a} sin θ - {m}_{L} {gd}_{L} - {m}_{c} {gd}_{c} - {m}_{R} {gd}_{R} - {m}_{FD} {gd}_{FD} = {α}_{L} ( ( {m}_{L} {R}_{L}^{2} + {I}_{L} ) + ( {m}_{c} {R}_{c}^{2} + {I}_{c} ) + ( {m}_{FC} {R}_{FD}^{2} + {I}_{FD} ) + ( {m}_{R} {R}_{R}^{2} ) )$$

Referring to FIG. 16, the weight estimator 614 may be configured to determine a refuse weight held by the refuse container 200 engaged by the lift assembly 40 that is operated by the electric motors 622. For example, the weight estimator 614 may receive the angular acceleration α_{L} of the lift arms 42 around the arm pivot point P_{A} from the acceleration estimator 612 and a torque τₘ applied by the electric motors 622 on the portion of the lift apparatus 620 from the torque controller 616 or the motor controller 618. Additionally, the weight estimator 614 may know the acceleration due to gravity g, a mass my of the lift arms 42, a horizontal distance d_{L} between the arm pivot point P_{A} and the center of mass of the lift arms 42, the distance R_{AD} between the arm pivot point P_{A} and the center of mass of the lift arms 42, a moment of inertia I_{L} of the lift arms 42, a mass m_{c} of the refuse container 200, a horizontal distance d_{c} between the arm pivot point P_{A} and the center of mass of the refuse container 200, a distance R_{c} between the arm pivot point P_{A} and the center of mass of refuse container 200, a horizontal distance d_{R} between the arm pivot point P_{A} and the center of mass of the refuse, a distance R_{R} between the arm pivot point P_{A} and the center of mass of refuse, a mass m_{FD} of the fork actuator 49, a horizontal distance d_{FD} between the arm pivot point P_{A} and a center of mass of the fork actuator 49, a distance R_{FD} between the arm pivot point P_{A} and the center of mass of the fork actuator 49, and a moment of inertia I_{FD} of the fork actuator 49. Based on this information, the weight estimator 614 may estimate the refuse weight m_{R} held by the lift assembly 50 by solving the equation below for m_{R} and multiplying m_{R} by g:

$${τ}_{m} - {m}_{L} {gd}_{L} - {m}_{c} {gd}_{c} - {m}_{R} {gd}_{R} - {m}_{FD} {gd}_{FD} = {α}_{L} ( ( {m}_{L} {R}_{L}^{2} + {I}_{L} ) + ( {m}_{c} {R}_{c}^{2} + {I}_{c} ) + ( {m}_{FD} {R}_{FD}^{2} + {I}_{FD} ) + ( {m}_{R} {R}_{R}^{2} ) )$$

In various embodiments, the weight estimator 614 may be configured to determine a refuse weight held by the refuse container 200 engaged by the forks 48 of the lift assembly 40 that are rotated relative to the lift arms 42 by the electric motors 622 or the electric actuators 624 using similar calculations to the calculations described above in relation to the lift arms 42.

In some embodiments, the weight estimator 614 may consider discrepancies between the measured torque measured at the electric motors 622 (e.g., by the lift sensor 626, etc.) and/or the measured force measured at the electric actuators 624 (e.g., by the lift sensor 626, etc.) and an actual torque applied by the electric motors 622 on the portion of the lift apparatus 620 and/or an actual force applied by the electric actuators 624 on the portion of the lift apparatus 620. For example, there may be a difference between the measured torque and the actual torque and/or the measured force and the actual force due to internal frictions of the lift apparatus 620. As another example, there may be a difference between the measured torque and the actual torque and/or the measured force and the actual force due to inefficiencies within the electric motors 622 and/or the electric actuators 624. The weight estimator 614 may apply a torque offset to the measured torque and/or a force offset to the measured torque to factor in these discrepancies and increase an accuracy of determining the weight of the refuse held by the refuse container 200.

In some embodiments, the weight estimator 614 may consider measured torques applied by the electric motors 622 on the portion of the lift apparatus 620 while lifting the lift apparatus 620 and while lowering the lift apparatus 620. According to the exemplary embodiment shown in FIG. 17, the weight estimator 614 may apply a torque offset to the measured torques of the electric motors 622 such that torque values utilized by the weight estimator 614 to determine the refuse weight held by the refuse container 200 are in between a first curve indicating first measured torques of the electric motors 622 while raising the lift apparatus 620 and a second curve indicating second measured torques of the electric motors 622 while lowering the lift apparatus 620. Since the torque values utilized by the weight estimator 614 to determine the refuse weight held by the refuse container 200 compensate for differences between the measured torques and the actual torques, the weight estimator 614 may determine a more accurate refuse weight held by the refuse container 200 than if the differences between the measured torques and the actual torques were not considered.

The torque controller 616 is configured to receive the user input from the HMI 630 and the weight of the lift apparatus 620 and the load on the lift apparatus 620 and determine an output torque applied by the electric motors 622 or the electric actuators 624 on the portion the lift apparatus 620 (e.g., the lift arms 42 of the lift assembly 40, etc.) based on the user input and the load on the lift apparatus 620, according to some embodiments. In some embodiments, the torque controller 616 is configured to determine the output torque of the electric motors 622 or the electric actuators 624 applied on the portion of the lift apparatus 620 based on the user input and the refuse weight being handled by the lift apparatus 620. In some embodiments, the torque controller 616 may determine the output torque by first determining a desired speed for operating the lift apparatus 620 based on the user input. For example, the HMI 630 may correspond with a range of speeds of the lift apparatus 620. When an operator of the HMI 630 operates the HMI 630 to create the user input, the user input may be within the range of speeds of the lift apparatus 620. The torque controller 616 may then determine the desired speed of the lift apparatus 620 based on where the user input is located within the range of speeds. For example, the HMI 630 may include a joystick with a base position and a maximum position. The base position of the joystick may correspond with the lift apparatus 620 having zero speed and the maximum position of the joystick may correspond with the lift apparatus having a maximum speed. The torque controller 616 may determine the desired speed of the lift apparatus 620 based on where the operator of the vehicle 10 positions the joystick between the base position and the maximum position. For example, if the operator positions the joystick halfway between the base position and the maximum position, the torque controller 616 may determine that the desired speed for the lift apparatus 620 is halfway between zero speed and the maximum speed. In other embodiments, the relationship between the HMI 630 and the desired speed is not linear (e.g., as the HMI 630 is adjusted the desired speed does not adjust at an equal rate to the adjustments to the HMI 630, etc.).

The torque controller 616 is configured to determine a desired torque for the electric motors 622 or the electric actuators 624 to apply on the portion of the lift apparatus 620 that will result in the lift apparatus 620 being operated at the desired speed. In some embodiments, the torque controller 616 may utilize dynamic equations and known component properties to determine the desired torque for the electric motors 622 or the electric actuators 624 to apply on the portion of the lift apparatus 620 based on the desired speed and the load on the lift apparatus 620 from the weight estimator 614. In some embodiments, the torque controller 616 may determine the desired torque for the electric motors 622 or the electric actuators 624 to apply on the portion of the lift apparatus 620 based on the desired speed and the estimated weight of the refuse being handled by the lift apparatus 620. For example, the torque controller 616 may determine that the electric motors 622 or the electric actuators 624 applying a desired torque on the portion of the lift apparatus 620 would result in the lift apparatus 620 moving at the desired speed based on the operational characteristics of the lift apparatus 620, the estimated weight of the refuse from the weight estimator 614, and the operational properties of the electric motors 622 or the electric actuators 624. The torque controller 616 may utilize similar dynamics equations to the equations described in relation to the weight estimator 614 to solve for the desired torque that results in the lift apparatus 620 being operated at the desired speed. In some embodiments, the torque controller 616 utilizes a computer model of the lift apparatus 620 and the estimated weight from the weight estimator 614 to determine the desired torque for the electric motors 622 or the electric actuators 624 to apply on the portion of the lift apparatus 620. For example, the torque controller 616 may access a computer model of the lift apparatus 620 of the vehicle 10 that an operational model of the lift apparatus 620. The torque controller 616 may input the estimated weight of the refuse handled by the lift apparatus 620 and the desired speed of the lift apparatus 620 into the computer model and the computer model may output a desired torque for the electric motors 622 or the electric actuators 624 to apply on the portion of the lift apparatus 620 that results in the lift apparatus 620 moving at the desired speed.

The torque controller 616 is configured to limit the desired torque for the electric motors 622 and/or the electric actuators 624 to apply on the portion of the lift apparatus 620 based on the load on the lift apparatus 620 being above a predetermined load threshold, according to some embodiments. In some embodiments, the torque controller 616 is configured to limit the desired torque for the electric motors 622 and/or the electric actuators 624 to apply on the portion of the lift apparatus 620 based on the estimated weight of the refuse being handled by the lift apparatus 620 being above a predetermined weight threshold such that a speed of the lift apparatus 620 is slower than the desired speed corresponding with the desired torque. The predetermined weight threshold may be a value of the refuse weight being handled by the lift apparatus 620 that could reduce an efficiency of the lift apparatus 620, cause high stress in the lift apparatus 620 or the vehicle 10, cause components in the lift apparatus 620 or the vehicle 10 to wear at an accelerated rate, cause instability in the lift apparatus 620 or the vehicle 10, not be achievable by the lift apparatus 620 or the vehicle 10 based on a maximum torque rating of the electric motors 622 or the electric actuators 624, not be achievable by the lift apparatus 620 or the vehicle 10 based on a maximum power output available, etc. Upon determining that the estimated weight is above the predetermined weight threshold, the torque controller 616 may limit the desired torque for the electric motors 622 and/or the electric actuators 624 to apply on the portion of the lift apparatus 620 to a value that will result in the lift apparatus 620 being operated at a maximum speed. In some embodiments, the maximum speed may depend on the estimated weight. For example, the maximum speed may be higher when the estimated weight is closer to the predetermined weight threshold than when the estimated weight is farther from the predetermined weight threshold. In various embodiments, the torque controller 616 is configured to alert an operator of the vehicle 10 that the estimated weight is above the predetermined weight threshold. For example, the torque controller 616 may alert the operator that the estimated weight is above the predetermined weight threshold though an alarm, a display, or the HMI 630.

The motor controller 618 is configured to generate a control signal for the electric motors 622 and/or the electric actuators 624 that will result in the electric motors 622 and/or the electric actuators 624 applying the desired torque on the portion of the lift apparatus 620 such that the lift apparatus 620 is operated at the desired speed. In some embodiments the motor controller 618 may be configured as a PID controller that relies on the feedback data from the lift sensor 626 to control the electric motors 622 and/or the electric actuators 624 to ensure that the electric motors 622 and/or the electric actuators 624 applies the desired torque on the portion of the lift apparatus 620 such that the lift apparatus 620 is operated at the desired speed.

In some embodiments, the torque controller 616 and the motor controller 618 are configured generate an initial control signal for the electric motors 622 and/or the electric actuators 624 to apply the initial torque (e.g., a first torque, etc.) on the portion of the lift apparatus 620 that results in the motion of the component of the lift apparatus 620 utilized by the acceleration estimator 612 to estimate the acceleration of the component of the lift apparatus 620. In some embodiments, the torque controller 616 and the motor controller 618 are configured to generate the initial control signal after receiving the user input from the HMI 630. For example, an operator of the vehicle 10 may operate the HMI 630 to create a user input for operating the lift apparatus 620. After receiving the user input, the torque controller 616 and the motor controller 618 may generate the initial control signal that causes the electric motors 622 and/or the electric actuators 624 to apply the initial torque on the portion of the lift apparatus 620 such that the acceleration estimator 612, the weight estimator 614, and the torque controller 616 can perform the functionality described above in order to determine the desired torque that corresponds to the user input. The motor controller 618 can then operate the electric motors 622 and/or the electric actuators 624 to apply the desired torque on the portion of the lift apparatus 620 such that the lift apparatus 620 is operated at the speed desired by the operator. In other embodiments, the torque controller 616 and the motor controller 618 automatically generate the initial control signal for the electric motors 622 and/or the electric actuators 624 after receiving an indication that the lift apparatus 620 has collected refuse. For example, the torque controller 616 and the motor controller 618 may generate the initial control signal after receiving an indication that the lift apparatus 620 has engaged the refuse container 200, after receiving an indication that a refuse container has been emptied into an intermediate container of the lift apparatus 620 (e.g., a container coupled to the lift apparatus 620 that acts as an intermediate repository for refuse before being transferred to the compartment 30 of the vehicle 10, etc.), after receiving an indication that the grabber assembly 52 has grabbed a refuse container, etc. By automatically generating the initial control signal after receiving the indication, the weight estimator 614 may determine the estimated weight of the refuse being handled by the lift apparatus 620 prior to the controller 602 receiving the user input to operate the lift apparatus 620 from the HMI 630.

In some embodiments, the torque controller 616 and the motor controller 618 are configured to increase a value of the initial torque of the initial control signal after determining that the initial torque applied by the electric motors 622 and/or the electric actuators 624 on the portion of the lift apparatus 620 did not result in the motion of the component of the lift apparatus 620, as the motion of the component of the lift apparatus 620 is utilized by the acceleration estimator 612 to estimate the acceleration of the component of the lift apparatus 620. The torque controller 616 and the motor controller 618 may be configured to increase the value of the initial torque until the initial torque results in the motion of the component of the lift apparatus 620. For example, the torque controller 616 and the motor controller 618 may generate an initial control signal corresponding to an initial torque that is not sufficient to result in motion of the component of the lift apparatus 620. The torque controller 616 and the motor controller 618 may receive the feedback data from the lift sensor 626 indicating that the initial torque did not result in motion of the component of the lift apparatus 620 and the torque controller 616 and the motor controller 618 may increase the value of the initial torque of the initial control signal until the initial torque results in the motion of the component of the lift apparatus 620.

In some embodiments, the torque controller 616 and the motor controller 618 are configured to utilize speed saturation controls to prevent over running of the electric motors 622 and/or the electric actuators 624. For example, the torque controller 616 and the motor controller 618 may limit a speed of the electric motors 622 and/or the electric actuators 624 such that a motion cycle of the lift apparatus 620 is kept below a predetermined cycle time.

In some embodiments, the lift apparatus 620 includes a gearbox 628 with multiple gearing ratios. In some embodiments, the gearbox 628 has two gearing rations. In other embodiments, the gearbox 628 has multiple gearing ratios. The gearbox 628 may be configured to change a gearing ratio of the lift apparatus 620 such that a speed of the lift apparatus 620 is reduced. For example, the gearbox 628 may be positioned at an output of the electric motors 622 and be configured to change a gearing ratio of the electric motors 622 such that the electric motors 622 is able operate the lift apparatus 620 at multiple different gearing ratios. As another example, the gearbox 628 may be part of the electric actuators 624 and be configured to change a gearing ratio of the electric actuators 624 such that the electric actuators 624 is able to operate the lift apparatus 620 at multiple different gearing ratios. In some embodiments, the torque controller 616 is configured to change the gearing ratio of the gearbox 628 based on the estimated weight being above the predetermined threshold. For example, after determining that the estimated weight is above the predetermined threshold, the torque controller 616 may be configured to generate a gearbox signal for the gearbox 628 that will result in the gearbox 628 changing the gearing ratio. The change in the gearing ratio may result in the electric motors 622 or the electric actuators 624 applying a torque on the portion of the lift apparatus 620 that will result in the lift apparatus 620 being operated at a speed that is lower than the desired speed. In some embodiments, the torque controller 616 is configured to select the gearing ratio of the gearbox based on the desired speed from the user input and the estimated weight from the weight estimator 614. For example, the gearbox 628 may include three gearing ratios and the torque controller 616 may select one of the gearing ratios based on the estimated weight. For example, for a high estimated weight (e.g., a weight above a high weight threshold, etc.), the torque controller 616 may select a low speed gear ratio. For a low estimated weight (e.g., a weight below a low weight threshold, etc.), the torque controller 616 may select a high speed gear ratio. For a medium estimated weight (e.g., a weight below the high weight threshold and above the low weight threshold, etc.), the torque controller 616 may select a medium speed gear ratio.

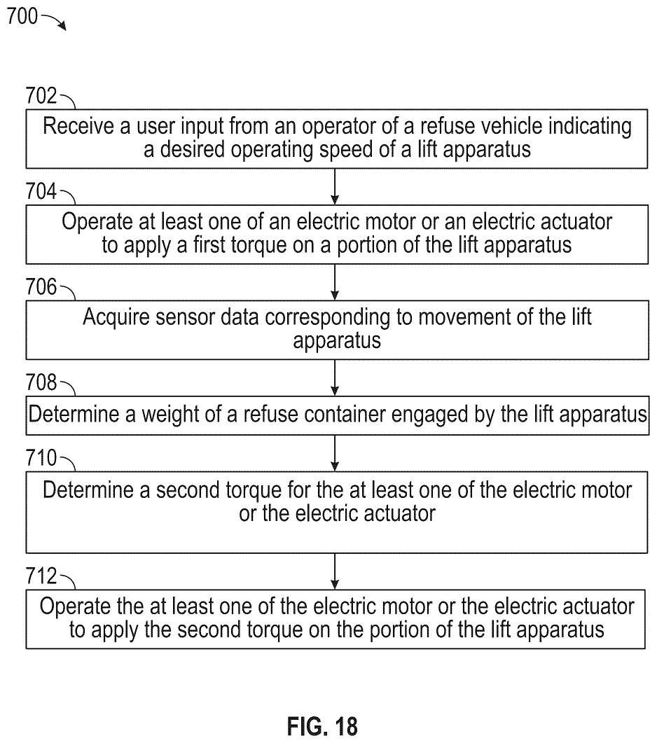

Referring to FIG. 18, a flow diagram of a process 700 for operating an electric lift system of an electric refuse vehicle includes steps 702-714, according to some embodiments. In some embodiments, the process 700 is performed by the controller 102 based on data obtained by one or more of the input devices 150 of the vehicle 10. In some embodiments, the process 700 is performed by the controller 602 based on data obtained from the lift sensors 626, the HMI 630, the refuse sensor 632, and the orientation sensor 634. The process 700 may be implemented in order to operate the lift apparatus 620.

The process 700 includes receiving a user input from an operator of a refuse vehicle indicating a desired speed of a lift apparatus (step 702), according to some embodiments. Step 702 can be performed by the controller 602 by receiving the user input from the HMI 630. In some embodiments, an operator of the refuse vehicle may provide the user input through an instrument of the HMI 630. For example, the operator of the refuse vehicle my manipulate a joystick of the HMI 630 to a position corresponding to the desired speed. For example, manipulating the joystick to a first position away from a base position may correspond to a first speed and manipulating the joystick to a second position that is further away from the base position than the first position may correspond to a second speed that is greater than the first speed.

The process 700 includes operating at least one of an electric motor or an electric actuator to apply a first torque on a portion of the lift apparatus (step 704), according to some embodiments. In some embodiments, the first torque is an initial torque applied by the at least one of the electric motor or the electric actuator on the portion of the lift apparatus. In some embodiments, the at least one of the electric motor or the electric actuator is configured to operate the lift apparatus of the refuse vehicle. Step 704 can be performed by the controller 602 by generating initial control signals (e.g., first control signals, etc.) for the electric motors 622 and/or the electric actuators 624 to apply the first torque on a portion of the lift apparatus 620 that results in motion of a component of the lift apparatus 620. In some embodiments, step 704 is performed after the controller 602 receives a user input from the HMI 630. In some, embodiments, step 704 is performed after the controller 602 receives an indication that the lift apparatus 620 is handling refuse. In some embodiments, the step 704 is repeated until motion of the lift apparatus 620 is detected. For example, the controller 602 may generate an initial control signal for the electric motors 622 and/or the electric actuators 624 to apply a first torque with a first value on the portion of the lift apparatus 620, but the first torque with the first value may not be sufficient to cause the motion of the component of the lift apparatus 620. The controller 602 may receive an indication that the component of the lift apparatus 620 did not move (e.g., that the lift apparatus 620 is stationary, etc.) from the lift sensor 626 and may increase the first torque to a second value that is higher than the first value and cause the electric motors 622 and/or the electric actuators 624 to reapply the first torque with the second value on the portion of the lift apparatus 620. If the first torque with the second value is sufficient to cause the motion of the component of the lift apparatus 620, the controller 602 may proceed to step 706. If the first torque with the second value is not sufficient to cause the motion of the component of the lift apparatus 620, the controller 602 may repeat the step 704 by increasing and reapplying the first torque until the component of the lift apparatus 620 moves (e.g., the lift apparatus 620 is no longer stationary, etc.).

The process 700 includes acquiring sensor data corresponding to movement of the lift apparatus (step 706), according to some embodiments. In some embodiments, the sensor data is acquired from one or more sensors configured to generate sensor data corresponding to movement of the lift apparatus. Step 706 can be performed by the input manager 610 of the controller 602 by acquiring the sensor data from the sensors 126 (e.g., the lift sensor 626, etc.).

The process 700 includes determining a weight of a refuse container being handled by the lift apparatus (step 708), according to some embodiments. The weight of the refuse container may include a weight of refuse held by the refuse container. In some embodiments, step 708 includes determining a weight of the lift apparatus 620 and/or a weight of refuse held by the refuse container 200 engaged by the lift apparatus 620. In other embodiments, the weight of the lift apparatus 620 and/or the weight of the refuse container 200 without refuse (e.g., when empty, etc.) may be known. Step 708 can be performed by the weight estimator 614 of the controller 602 by determining the weight of the refuse container 200 being handled by the lift apparatus 620 based on the first torque applied by the at least one of the electric motors 622 or the electric actuators 624 on the portion of the lift apparatus 620 in step 704 and the sensor data acquired in step 706. The weight of the refuse container 200 may include a weight of refuse held by the refuse container 200. The weight estimator 614 can determine the weight of the refuse container 200 using dynamic equations and known component properties. In some embodiments, the weight estimator 614 can determine the weight of the refuse container 200 based on the refuse data from the refuse sensor 632. For example, the refuse sensor 632 may be configured to measure pin stress at pins of the lift apparatus 620 and the weight estimator 614 may relate the pin stress at the pins to the weight of the refuse container 200.

In some embodiments, the weight of the refuse container being handled by the lift apparatus is determined based on an acceleration of a component of the lift apparatus and the first torque applied by the at least one of the electric motor or the electric actuator on the portion of the lift apparatus. The acceleration estimator 612 of the controller 602 may determine the acceleration of the component of the lift apparatus by determining the acceleration of the component of the lift apparatus 620 based on feedback data (e.g., sensor data, etc.) received from the lift sensor 626. Step 706 may include determining a linear acceleration of the component of the lift apparatus 620 and/or an angular acceleration of the component of the lift apparatus 620. For example, if the lift apparatus 620 is the lift assembly 40, step 706 may include determining the angular acceleration of the lift arms 42 of the lift assembly 40. As another example, if the lift apparatus 620 is the lift assembly 50, step 706 may include determining the linear acceleration of the grabber assembly 52 of the lift assembly 50. In some embodiments, the acceleration estimator 612 is configured to determine the acceleration of the component of the lift apparatus 620 using an acceleration of the electric motors 622 and/or the electric actuators 624 and kinematic relationships of the lift apparatus 620. In other embodiments, the lift sensor 626 may be configured to measure the acceleration of the component of the lift apparatus 620 and may provide the acceleration of the component of the lift apparatus 620 to the acceleration estimator 612.

Process 700 includes determining a second torque for the at least one of the electric motor or the electric actuator (step 710), according to some embodiments. In some embodiments, the second torque (e.g., the desired torque, etc.) may be determined based on the weight of the refuse container and the desired speed received during step 702. In some embodiments, step 710 can be performed by the torque controller 616 of the controller 602. In some embodiments, the torque controller 616 is configured to determine the desired speed of the lift apparatus 620 based on a user input received from the HMI 630 and determine the second torque for the electric motors 622 and/or the electric actuators 624 to apply on the portion of the lift apparatus 620 based on the desired speed of the lift apparatus 620 and the weight of the refuse container 200 determined in step 708. For example, an operator of the vehicle 10 may operate a joystick to a first position that corresponds with a desired speed of the lift apparatus 620. The torque controller 616 may determine the desired speed based on the joystick being in the first position and may determine the second torque for the electric motors 622 and/or the electric actuators 624 to apply on the portion of the lift apparatus 620 that corresponds with the lift apparatus 620 operating at the desired speed based on the weight of the refuse container 200 being handled by the lift apparatus 620. In some embodiments, the torque controller 616 is configured to limit the first torque based on the weight of the container 200 exceeding a refuse weight threshold.

Process 700 includes operating the at least one of the electric motor or the electric actuator to apply the second torque on the portion of the lift apparatus (step 712), according to some embodiments. In some embodiments, step 712 can be performed by the motor controller 618 of the controller 602. In some embodiments, the motor controller 618 provides a control signal to the electric motors 622 and/or the electric actuators 624 to apply the second torque on the portion of the lift apparatus 620 such that the lift apparatus 620 is operated at the desired speed.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A refuse vehicle comprising:
a chassis;
a body coupled to the chassis;
a lift apparatus coupled to at least one of the chassis or the body and configured engage a refuse container to collect refuse stored within the refuse container;
at least one of an electric motor or an electric actuator configured to drive the lift apparatus;
one or more sensors configured to generate sensor data corresponding to movement of the lift apparatus; and
one or more processing circuits configured to:
receive a user input from an operator of the refuse vehicle indicating a desired operating speed of the lift apparatus;
operate the at least one of the electric motor or the electric actuator to apply a first torque on a portion of the lift apparatus;
acquire, from the one or more sensors, the sensor data;
determine, based on the first torque and the sensor data, a weight of the refuse container engaged by the lift apparatus;
determine, based on the weight of the refuse container and the desired operating speed, a second torque for the at least one of the electric motor or the electric actuator; and
operate the at least one of the electric motor or the electric actuator to apply the second torque on the portion of the lift apparatus.

2. The refuse vehicle of claim 1, wherein:
the one or more processing circuits are configured to determine, based on the sensor data, an acceleration of a component of the lift apparatus; and
the one or more processing circuits utilize the acceleration of the component of the lift apparatus to determine the weight of the refuse container.

3. The refuse vehicle of claim 2, wherein the one or more processing circuits are configured to utilize kinematic relationships associated with the lift apparatus to determine the weight of the refuse container.

4. The refuse vehicle of claim 1, wherein the one or more processing circuits are configured to operate the at least one of the electric motor or the electric actuator to apply the first torque on the portion of the lift apparatus prior to receiving the user input from the operator of the refuse vehicle indicating the desired operating speed of the lift apparatus.

5. The refuse vehicle of claim 1, wherein:
the first torque has a first torque value; and
responsive to the sensor data indicating that the lift apparatus is stationary and prior to determining the weight of the refuse container, the one or more processing circuits are configured to:
modify the first torque from the first torque value to a second torque value, the second torque value higher than the first torque value; and
operate the at least one of the electric motor or the electric actuator to reapply the first torque on the portion of the lift apparatus such that the lift apparatus is no longer stationary.

6. The refuse vehicle of claim 1, wherein the one or more processing circuits are configured to operate the at least one of the electric motor or the electric actuator to apply the first torque on the portion of the lift apparatus responsive to the one or more processing circuits receiving the user input.

7. The refuse vehicle of claim 1, wherein the one or more processing circuits are configured to determine, based on the first torque and the sensor data, a weight of refuse held by the refuse container.

8. The refuse vehicle of claim 1, wherein when the one or more processing circuits determine the weight of the refuse container, the one or more processing circuits are configured to apply a torque offset to the first torque, the torque offset corresponding to inefficiencies associated with the at least one of the electric motor or the electric actuator.

9. The refuse vehicle of claim 1, wherein, responsive to the weight of the refuse container exceeding a weight threshold, the one or more processing circuits are configured to limit the second torque such that the lift apparatus is operated at a speed slower than the desired operating speed.

10. The refuse vehicle of claim 1, wherein after operating the at least one of the electric motor or the electric actuator to apply the second torque on the portion of the lift apparatus, the one or more processing circuits are configured to:
acquire, from the one or more sensors, updated sensor data;
determine, based on the updated sensor data, that the lift apparatus is being operated at a speed slower than the desired operating speed; and
operate the at least one of the electric motor or the electric actuator to apply a third torque on the portion of the lift apparatus such that the lift apparatus is operated at the desired operating speed, the third torque higher than the second torque.

11. The refuse vehicle of claim 1, further comprising one or more lift apparatus sensors configured to generate engagement data corresponding to the lift apparatus engaging the refuse container;
wherein the one or more processing circuits are configured to:
acquire, from the one or more lift apparatus sensors, the engagement data; and
determine, based on the engagement data, that the lift apparatus has engaged the refuse container; and
wherein the one or more processing circuits are configured to operate the at least one of the electric motor or the electric actuator to apply the first torque on the portion of the lift apparatus responsive to determining that the lift apparatus has engaged the refuse container.

12. A refuse vehicle comprising:
a chassis;
a body coupled to the chassis;
a lift apparatus coupled to at least one of the chassis or the body and configured engage a refuse container to collect refuse stored within the refuse container;
at least one of an electric motor or an electric actuator configured to drive the lift apparatus;
one or more first sensors configured to generate first sensor data corresponding to the lift apparatus engaging the refuse container;
one or more second sensors configured to generate second sensor data corresponding to movement of the lift apparatus; and
one or more processing circuits configured to:
acquire, from the one or more first sensors, the first sensor data;
determine, based on the first sensor data, that the lift apparatus has engaged the refuse container;
operate the at least one of the electric motor or the electric actuator to apply a first torque on a portion of the lift apparatus;
acquire, from the one or more second sensors, the second sensor data; and
determine, based on the first torque and the second sensor data, a weight of the refuse container.

13. The refuse vehicle of claim 12, further comprising a display;
wherein the one or more processing circuits are configured to control the display to provide the weight of the refuse container to an operator of the refuse vehicle.

14. The refuse vehicle of claim 12, wherein the one or more processing circuits are configured to:
receive a user input from an operator of the refuse vehicle indicating a desired operating speed of the lift apparatus;
determine, based on the weight of the refuse container and the desired operating speed, a second torque for the at least one of the electric motor or the electric actuator to apply on the portion of the lift apparatus, the second torque higher than the first torque; and
operate the at least one of the electric motor or the electric actuator to apply the second torque on the portion of the lift apparatus.

15. The refuse vehicle of claim 14, wherein, responsive to the weight of the refuse container exceeding a weight threshold, the one or more processing circuits are configured to limit the second torque such that the lift apparatus is operated at a speed slower than the desired operating speed.

16. The refuse vehicle of claim 12, wherein:
the first torque has a first torque value; and
responsive to the second sensor data indicating that the lift apparatus is stationary and prior to determining the weight of the refuse container, the one or more processing circuits are configured to:
modify the first torque from the first torque value to a second torque value, the second torque value higher than the first torque value; and
operate the at least one of the electric motor or the electric actuator to reapply the first torque on the portion of the lift apparatus such that the lift apparatus is no longer stationary.

17. The refuse vehicle of claim 12, wherein the one or more processing circuits are configured to operate the at least one of the electric motor or the electric actuator to apply the first torque on the portion of the lift apparatus responsive to determining that the lift apparatus has engaged the refuse container.

18. A method for operating a lift apparatus of a refuse vehicle comprising:
receiving a user input from an operator of the refuse vehicle indicating a desired operating speed of the lift apparatus;
operating at least one of an electric motor or an electric actuator of the refuse vehicle to apply a first torque on a portion of the lift apparatus;
acquiring, from one or more sensors, sensor data corresponding to movement of the lift apparatus;
determining, based on the first torque and the sensor data, a weight of a refuse container engaged by the lift apparatus;
determining, based on the weight of the refuse container and the desired operating speed, a second torque for the at least one of the electric motor of the electric actuator, the second torque higher than the first torque; and
operating the at least one of the electric motor or the electric actuator to apply the second torque on the portion of the lift apparatus.

19. The method of claim 18, wherein, responsive to the weight of the refuse container exceeding a weight threshold, the second torque is limited such that the lift apparatus is operated at a speed slower than the desired operating speed.

20. The method of claim 18, further comprising:
acquiring, from one or more lift apparatus sensors configured to generate engagement data corresponding to the lift apparatus engaging the refuse container; and
determining, based on the engagement data, that the lift apparatus has engaged the refuse container;
wherein the at least one of the electric motor or the electric actuator are operated to apply the first torque on the portion of the lift apparatus responsive to determining that the lift apparatus has engaged the refuse container.
